(19) United States
(12) Patent Application Publication
(10) Pub. No.: US 2023/0165203 A1
(43) Pub. Date: Jun. 1, 2023

(54) System and Method for Cultivation of Plants

(71) Applicant: URBAN CROP SOLUTIONS BV, Beveren-Leie (BE)

(72) Inventors: Maarten P.J.I. Vandecruys, Kortrijk (BE); Jean-Pierre Coene, Aalter (BE)

(21) Appl. No.: 17/997,425

(22) PCT Filed: Apr. 30, 2021
(86) PCT No.: PCT/EP2021/061370

§ 371 Date: Oct. 28, 2022

(30) Foreign Application Priority Data
Apr. 30, 2020 (BE) BE2020/5285

(51) Int. Cl. A01G 31/04

(52) U.S. Cl. CPC A01G 31/042

(57) ABSTRACT

The present invention relates to the technical field of indoor plant cultivation facilities for the cultivation of e.g., crops and/or herbs. Specifically, it relates to a system and method for cultivation of plants by means of a conveyor system.

### CROSS REFERENCE TO RELATED APPLICATIONS

This application is a national phase entry under 35 U.S.C. § 371 of International Patent Application PCT/EP2021/061370, filed Apr. 30, 2021, designating the United States of America and published in English as International Patent Publication WO 2021/219837 on Nov. 4, 2021, which claims the benefit under Article 8 of the Patent Cooperation Treaty to Belgium Patent Application Serial No. 2020/5285, filed Apr. 30, 2020, the entireties of which are hereby incorporated by reference.

### FIELD OF THE INVENTION

The present invention relates to the technical field of indoor plant cultivation facilities for the cultivation of e.g., crops and/or herbs. Specifically, it relates to a system and method for cultivation of plants by means of a conveyor system.

### BACKGROUND

Cultivation of plants like e.g., crops or herbs has traditionally been performed outdoors on farmlands or gardens. However, the growth of population has substantially reduced the amount of available soil. Moreover, growing awareness about pollution, such as the presence of chemical residues or contaminants in the environment, is driving industry to shift to cleaner methods of plant cultivation. One such cleaner alternative involves the use of indoor plant cultivation systems where plants are grown in an environment under carefully monitored and controlled growing conditions, e.g., indoor vertical farming.

Indoor plant cultivation has various advantages over the more traditional outdoor cultivation. For instance, the indoor climate can be fully controlled not only to optimise the growing conditions for the desired plants, but also enable to grow plant varieties from different regions of the planet, which would otherwise not grow under local climate conditions. Also, the plants can be fully protected from harmful environmental effects, such as too cold or hot weather, diseases, and invasive insect species, thereby alleviating the need for pesticides. As such, the system can produce a highly predictable yield year-round and ensure commercial viability.

However, current indoor cultivation technology has large operational costs because of an inefficient use of space and resources, requires laborious work, is not very user friendly, requires expensive installations and/or is only suitable for growing a small variety of plants per system. Existing plant cultivation systems may comprise a conveyor in which plant benches move in the horizontal direction over conveyor rollers. An operator which is positioned at one end of a rack can place the plant benches one by one in a row. Once the first plant bench reaches the end of the row, i.e., the end away from the operator, plant benches can be lifted to the underneath row e.g., manually or by an elevator. The plant benches then move on the lower row back to the operator on conveyor rollers. Once the first plant bench reaches the operator side, the operator can take the bench out of the plant cultivation system. This has the disadvantage that in case an operator wants to take out one of the plant benches from of the plant cultivation system, e.g., because the plants need inspection or additional care, the operator needs to take out all plant benches which are on the conveyor rollers and place them back into the plant cultivation system until the designated plant bench reaches the operator.

Therefore, there is a need for novel plant cultivation systems and methods that may allow the cultivation of a broad variety of plants in a more efficient manner and/or requiring less manual labour.

### SUMMARY OF THE INVENTION

The present invention is in the field of plant cultivation systems, i.e., systems for growing plants in a controlled environment. The present invention provides a system for cultivating plants in plant benches, optionally being provided with plant trays, comprising an endless conveyor. The plant benches and optional trays are spatially arranged in a rack by means of a controllable conveyor system, which conveys the benches along at continuous conveying path through at least two rows of said rack; i.e., the conveyor system creates an endless loop between at least two rows, whereby when a bench reaches the end of one row, for example a first row, it can continue at the start of the other row, for example a second row, and vice versa. The conveyor system may be configured for conveying the benches in different directions, e.g., forward and backward, or downward and upward. This way a continuous rotating conveyor system is achieved wherein plants are conveyed towards the operator of said system, like a plant operator. Also, the benches may be reversibly attached to the conveyor system, i.e., the benches can be attached to and detached from the conveyor system.

The present invention in a first aspect relates to a system for the cultivation of plants comprising:

a plurality of benches for cultivating plants;

a rack comprising a pair of elongated rows, the rows being arranged one above the other, each row providing space for holding at least two benches;

a conveyor system comprising at least two endless conveyor chains and a conveyor drive means configured for driving said conveyor chains;

wherein the conveyor chains are arranged parallel to each other at opposite sides of the rack and wherein each conveyor chain extends longitudinally along the length of the rack;

wherein the conveyor chains define a bench conveying path having a substantially horizontal portion running along one row, a substantially horizontal portion running along the other row, and two side portions connecting said substantially horizontal portions; and,

wherein each of the plurality of benches is pivotally attached to the conveyor chains such that each of the plurality of benches is conveyable along the bench conveying path.

The present plant cultivation system allows benches to move at the operator's demand and gives quick access to each of the plant benches. This overcomes the problems associated with a first-in first-out principle. The present plant cultivation system allows to cultivate plants with different growing speeds as the plants can easily be harvested at any point in time. As the plant benches—and hence the plants—are moving towards the operator, the operator can keep on working from one fixed location. Also, the plant cultivation system maximizes the efficiency of the use of space in a three-dimensional environment.

The present invention in a further aspect relates to a system for cultivation of plants, comprising:

a plurality of benches for cultivating plants;

a rack comprising a pair of elongated rows, one arranged above the other; each row providing space for holding at least two benches and comprising means for providing growing conditions suitable for the cultivation of plants;

a conveyor system comprising at least two endless conveyor chains, arranged in a parallel manner on opposite sides of the rack and extending longitudinally along the length of the rack so as to define a bench conveying path having a substantially horizontal portion running along one row, a substantially horizontal portion running along the other row, and two side portions connecting said substantially horizontal portions; wherein every bench is pivotally attached to the conveyor chains and is conveyable along said bench conveying path;

characterised in that the system system comprises a conveyor drive for driving the conveyor chains, and a control unit operatively connected to said conveyor drive and configured for controlling the conveyor system to

convey the plurality of benches along the bench conveying path until at least one bench reaches a side portion, and then stopping said bench at a position along the side portion suitable for planting one or more immature plants and/or harvesting of mature plants; and,

convey the plurality of benches along the bench conveying path until every bench reaches a horizontal portion of the bench conveying path, and then stopping the benches at a position along the horizontal portions suitable for providing growing conditions until the immature plants develop into mature plants.

In addition to the above-described improved operator control, the present plant cultivation system may allow the growth of plants in batches, as opposed to the continuous advancement of plants along a continuously running conveyor system. This overcomes the problems associated with a constantly operating system to reduce the energy consumption and/or thereby increase the efficiency of the system. Also, the present plant cultivation system allows for cultivating plants with different growing speeds since the growing conditions can be easily adapted for every plant and/or every bench, which is difficult in continuously advancing conveyor systems. In some embodiments the system is a system for batchwise cultivation of plants.

In some embodiments, the conveyor system is configured for:

stopping the conveying of benches along the bench conveying path when at least one bench is positioned at a side portion of the bench conveying path; and/or

stopping the conveying of benches along the bench conveying path when all benches are positioned at a horizontal portion of the bench conveying path.

In some embodiments the conveyor drive means comprises at least two rotary actuators, wherein the at least two rotary actuators are arranged for driving at least one conveyor chain, preferably wherein the at least two rotary actuators are rotatably coupled by a common drive shaft.

In some embodiments, each bench is reversibly attached to the conveyors; and/or wherein each bench has opposing ends and comprises a conveyor attachment means such as hook at each opposing end, and each conveyor chain comprises a transverse member, wherein said conveyor attachment means such as said hooks are hooked over said transverse members such that the bench is reversibly attached to the conveyor chains.

In some embodiments, the plant cultivation system comprises a lighting system, preferably for providing light suitable for the cultivation of plants, said lighting system comprising at least one retractable lamp configured to retract during the conveying of benches along the bench conveying path.

In some embodiments the plant cultivation system comprises a lighting system, preferably for providing light suitable for the cultivation of plants, the lighting system comprising at least one retractable lamp configured to retract when a bench passes a side portion of the bench conveying path.

In some embodiments, the at least one retractable lamp is arranged at each end of each row of the plant cultivation system. Such lighting system advantageously avoids collision of a plant bench with the lighting system when the plant bench passes a side portion of the bench conveying path.

In some embodiments the plant cultivation system comprises a fluidic system, preferably for providing fluid suitable for the cultivation of plants, said fluidic system comprising at least one fluid dispensing tube for dispensing fluid into the bench and at least one gutter for draining the dispensed fluid; and optionally, at least one bench drain spout for guiding the dispensed fluid from the bench into the gutter.

In some embodiments the plant cultivation system comprises a fluidic system, preferably for providing fluid suitable for the cultivation of plants, said fluidic system comprising at least one retractable fluid dispensing tube configured to retract during the conveying of benches along the bench conveying path.

In some embodiments the plant cultivation system comprises a fluidic system, preferably for providing fluid suitable for the cultivation of plants, the fluidic system comprising at least one retractable fluid dispensing tube configured to retract when a bench passes a side portion of the bench conveying path.

In some embodiments the at least one retractable fluid dispensing tube is arranged at each end of each row of the plant cultivation system.

In some embodiments, the plant cultivation system comprises a fluidic system, preferably for providing fluid suitable for the cultivation of plants, said fluidic system comprising an irrigation zone, wherein the irrigation zone is arranged along the length of one or more bench positions of the row but not at the bench position at the ends of each row. Such fluidic systems advantageously avoid collision of a plant bench with the fluidic system when the plant bench passes a side portion of the bench conveying path.

The present invention in a further aspect relates to a plant cultivation facility comprising a housing and a plant cultivation system as described herein, preferably arranged in said housing; preferably wherein the facility comprises at least two plant cultivation systems as described herein which are placed adjacent to each other; more preferably wherein the facility comprises two plant cultivation systems as described herein which are placed one above the other. In some embodiments, the housing is at least one modular container such as a shipping container. In some embodiments, the housing is an existing building.

The present invention in a further aspect relates to a method for cultivation of plants, preferably in a plant cultivation system or plant cultivation facility as described herein, said method comprising at least the steps:

(a) providing at least one immature plant for cultivation;

(b) conveying a plurality of benches along a bench conveying path until a bench reaches a side portion of the bench conveying path and then stopping the conveying of benches;

(c) planting the immature plant in the bench positioned at the side portion of the bench conveying path;

(d) conveying the plurality of benches along the bench conveying path until each bench reaches a horizontal portion of the bench conveying path and then stopping the conveying of benches; and

(e) providing growing conditions suitable for plant cultivation until the immature plant develops into a mature plant.

The present invention in a further aspect relates to a method for cultivation of plants, preferably in a plant cultivation system or plant cultivation facility as described herein, comprising at least the steps:

(a) providing one or more immature plants for cultivation;

(b) conveying a plurality of benches along a bench conveying path until at least one bench reaches a side portion of said bench conveying path, and then stopping the conveying of benches;

(c) planting the immature plants in the bench positioned along the side portion of the bench conveying path;

(d) further conveying the plurality of benches along the bench conveying path until every bench reaches a horizontal portion of the bench conveying path, and then stopping the conveying of benches; and

(e) providing growing conditions suitable for plant cultivation until the immature plants develop into mature plants.

In some embodiments at least steps (a) to (c) are repeated until every bench contains a plant; preferably at least one immature plant.

In some embodiments the method is a method for batchwise cultivation of plants. In some embodiments the method further comprises the steps:

(f) conveying the plurality of benches along the bench conveying path until the bench containing the mature plant reaches a side portion of the bench conveying path and then stopping the conveying of benches; and

(g) harvesting of the mature plant.

In some embodiments at least steps (f) to (g) are repeated until at least a portion of the mature plants, preferably all of the mature plants, have been harvested.

In some embodiments, the methods further comprise the steps:

designating a bench for a plant handling action, optionally by receiving an operator input;

conveying the plurality of benches along the bench conveying path until the designated bench reaches a side portion of the bench conveying path and then stopping the conveying of benches; and

performing one or more plant handling actions on the bench positioned along the side portion of the bench conveying path; wherein the plant handling actions are selected from the group consisting of introducing plants, transplanting plants, harvesting plants, inspecting plants, treating plants, and/or removing plants.

In some embodiments, the side portion of the bench conveying path is adjacent to an operator area.

In some embodiments, the methods further comprise the steps:

retracting of a retractable lamp and/or retractable fluid dispensing tube during the conveying of benches along the bench conveying path; and,

extending of the retractable lamp and/or retractable fluid dispensing tube after stopping the conveying of benches and when all benches are positioned at a horizontal portion of the bench conveying path.

In some embodiments, the methods further comprise the steps:

designating one or more benches for irrigation;

conveying a plurality of benches along a bench conveying path until the designated benches reach a horizontal portion of the bench conveying path that aligns with a fluidic system configured for irrigating benches, and then stopping the conveying of benches; and

irrigating the one or more designated benches.

The present invention in a further aspect relates to a use of the plant cultivation system as described herein and/or the plant cultivation facility as described herein for cultivating plants. In some embodiments, the plants are grasses, leafy greens, vegetables, herbs, succulents, algae, halophytes, flowering plants and/or medicinal plants.

The present invention in a further aspect relates to the plant cultivation system as described herein and/or the plant cultivation facility as described herein that is configured for performing the method as described herein.

### BRIEF DESCRIPTION OF THE DRAWINGS

Throughout the drawings, the corresponding reference numerals indicate the following parts and features: (100) plant cultivation system; (150) plant cultivation facility; (160) germination rack; (170) operator area; (180) technical room; (200) plant bench; (220) conveyor attachment means; (230) plant tray; (300) rack; (310) upper row; (320) lower row; (400) conveyor system; (410) conveyor chain; (420) transverse member; (450) conveyor drive; (455) sprocket; (460) motor; (465) drive chain; (470) drive shaft; (500) lighting system; (520) stationary lamp; (550) retractable lamp; (555) lamp retracting means; (580) lamp fastening clip; (600) fluidic system; (610) fluid dispensing tube; (620) retractable fluid dispensing tube; (650) fluid draining gutter.

The following figures and corresponding description of the figures illustrate specific and preferred embodiments of the present invention. Accordingly, the figures and the corresponding description are merely exemplary in nature and not intended to limit the present teachings, their application or uses. The scope of the present disclosure is by no means limited to these illustrative examples.

FIG. 1 is a schematic of a plant cultivation system (100).

FIG. 2A is a schematic of a plant cultivation facility (150).

FIG. 2B is a side view of a plant cultivation facility (150).

FIG. 3 is a side perspective view of a plant bench (200) comprising a plant tray (230) according to an embodiment of the present invention (upper panel) and of a plant bench (200) according to an embodiment of the present invention (lower panel).

FIG. 4 is a side perspective view of a plant bench reversible conveyor attachment means (220) and transverse member (420).

FIG. 5 is a top perspective view of a conveyor system (400).

FIG. 6 is a side perspective view of a conveyor system (400).

FIG. 7 is a side perspective view of a lighting system (500).

FIG. 8A is a schematic of a retractable lighting system (500).

FIG. 8B is a side perspective view of a retractable lighting system (500).

FIG. 9 is a perspective view of a fluidic system (600).

FIG. 10 is a schematic of a fluidic system (600).

### DETAILED DESCRIPTION

The present invention will be described with respect to particular embodiments, but the invention is not limited thereto but only by the claims. Any reference signs in the claims shall not be construed as limiting the scope thereof.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps. The recitation of numerical ranges by endpoints includes all numbers and fractions subsumed within the respective ranges, as well as the recited endpoints.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or s definitions used herein are provided solely to aid in the understanding of the invention. All documents cited in the present specification are hereby incorporated by reference in their entirety.

The terms “left,” “right,” “front,” “back,” “top,” “bottom,” “over,” “under,” “superior,” “inferior,” “lateral,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical (i.e., physical) manner Objects described herein as being “adjacent to” each other may be in physical contact with each other, in close proximity to each other, or in the same general region or area as each other, as appropriate for the context in which the phrase is used.

The term “about” is used to provide flexibility to a numerical range endpoint by providing that a given value may be “a little above” or “a little below” the endpoint. Unless otherwise stated, use zo of the term “about” in accordance with a specific number or numerical range should also be understood to provide support for such numerical terms or range without the term “about”. For example, for the sake of convenience and brevity, when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed. The term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Occurrences of the phrase “in one embodiment,” or “in one aspect,” herein do not necessarily all refer to the same embodiment or aspect. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims and description, any of the claimed or described embodiments can be used in any combination. In addition, it should be understood that embodiments of the invention may include hardware, software, and electronic components or modules that, for purposes of discussion, may be illustrated and described as if the majority of the components were implemented solely in hardware or software. However, one of ordinary skill in the art, and based on a reading of this detailed description, would recognize that, in at least one embodiment, the electronic based aspects of the invention may be implemented in software (e.g., instructions stored on non-transitory computer-readable medium) executable by one or more processing units, such as a microprocessor and/or application specific integrated circuits.

Accordingly, the herein described hardware such as the control unit may comprise a processing device that is configured for executing the herein presented methods as software. Embodiments of the methods may be implemented in code and may be stored on a storage medium having stored thereon instructions which can be used to program a system to perform the instructions. For purposes of the present disclosure, the terms “code” or “program” cover a broad range of components and constructs, including applications, drivers, processes, routines, methods, modules, and subprograms. The terms “code” or “program” may thus be used to refer to any collection of instructions which, when executed by a processing system, performs a desired operation or operations. Additionally, alternative embodiments may include processes that use fewer than all of the disclosed operations, processes that use additional operations, processes that use the same operations in a different sequence, and processes in which the individual operations disclosed herein are combined, subdivided, or otherwise altered. Those skilled in the art can appreciate the numerous modifications and variations thereon.

The present disclosure is in the field of indoor plant cultivation systems, i.e., systems for growing plant in a closed and controlled environment. The present disclosure provides a system and method for cultivating plants in plant benches, optionally being provided with plant trays. These benches and optional trays are spatially arranged in a rack by means of a controllable conveyor system, which conveys the benches along at continuous conveying path through at least two rows of said rack; i.e., the conveyor system creates an endless loop between at least two rows, whereby when a bench reaches the end of one row, for example a first row, it can continue at the start of the other row, for example a second row, and vice versa. The conveyor system may be configured for conveying the benches in different directions, e.g., forward and backward, or downward and upward. This way a continuous rotating conveyor system is achieved wherein plants are conveyed towards the operator of said system, like a plant handler. Also, the benches may be reversibly attached to the conveyor system, i.e., the benches can be attached to and detached from the conveyor system.

As a result of the herein described configuration the present system may provide for various improvements over systems of the art. For instance, the present system may provide for reduced operational costs as a result of a more efficient use of space and resources. The present system may be easily adapted for cultivation of a broad variety of plants, which may require different growing conditions. Also, the present system is user-friendly with the amount of manual labour required for operating the present system being substantially reduced.

The present system may further allow the growth of plants in batches, i.e., batchwise cultivation, as opposed to the continuous advancement of plants along a continuously running conveyor system. This overcomes the problems associated with a constantly operating system to reduce the energy consumption and/or thereby increase the efficiency of the system. Also, the present plant cultivation system allows for cultivating plants with different growing speeds since the growing conditions can be easily adapted for every plant and/or every bench, which is difficult for continuously advancing conveyor system. Additional technical advantages may be found detailed throughout the description.

Generally speaking, different stages of plant growth from an immature plant to a mature plant may include a germination stage followed by vegetative growth. These terms are defined as follows:

The terms “germination”, “germination stage”, “seed-to-seedling”, or “seed to seedling” may be used interchangeably herein and generally refer to the stage of plant growth wherein a seed develops into a seedling.

The terms “vegetative growth”, “seedling-to-harvest”, “seedling to harvest” or “seedling-to-harvest stage” may be used interchangeably herein and generally refer to the stage of plant growth wherein a seedling develops into a harvest plant. The number of substages typically depends on plant species. Growing conditions may also vary from one substage to the other, according to predetermined parameters.

The term “immature plants” as used herein refers to plants and/or plant parts which are not intended to be harvested. In particular, the term “immature plants” may include seeds, seedlings, and sprouts, provided that these plants are not intended to be harvested.

The term “mature plants” as used herein refers to plants and/or plant parts which are intended to be harvested, such as harvest plants. In particular, the term “mature plants” may include seeds, seedlings, sprouts, and adult plants provided that these plants and/or plant parts are intended to be harvested.

The plants may need to be handled by an operator during various stages of their growth. The handling of plants may include the actions of introducing plants (e.g., immature plants), transplanting plants (e.g., transplanting immature plants to a different planting density), harvesting plants (e.g., mature plants), inspecting plants, removing plants or other plant-related actions.

The system and method of the present disclosure are particularly well suited for cultivation of grasses, leafy greens, vegetables, herbs, succulents, algae, halophytes, flowering plants and/or medicinal plants. Nonetheless, the invention may also be suitable for cultivation of other plant types requiring little to no adjustments. The key growing conditions that plants require are temperature, humidity, ventilation, light, water, nutrients and carbon dioxide. The system and method of the present disclosure may also provide improved means for controlling these growing conditions, such as a lighting system, fluidic system, etc., which are discussed further throughout the description.

In embodiments, the plants or plant species intended to be cultivated (and hence intended to grow or growing) in the plant cultivation system may comprise herbaceous plants.

The term “herbaceous plant” refers to vascular plants that have no persistent woody stems above ground. In certain embodiments, the herbaceous plants comprise vegetables, herbs, halophytes, and medicinal plants.

Examples of vegetables, including all kinds of leafy greens, include green lettuce, red lettuce, romaine lettuce, iceberg lettuce, chop suey greens, endive, golden purslane, mina, mizuna, komatsuna, pakchoi, spinach, swiss chard, ruby chard, red mustard, watercress, redskin dwarf sweet pepper, radicchio, baby peppers, bok choy, Chinese broccoli, Chinese celery, curry leaves, lemon grass, pea shoots, sesame leaves, choy sum, tatsoi, frilly mustard, baby spinach, bloomsdale spinach, dakon sprout, salad savoy, frisee, green oakleaf, baby leek, garlic chives, marjoram, purslane sorrel, tarragon, broccoleaf, collard greens, dandelion greens, honey gem lettuce, kohlrabi, mesclun, miner's lettuce, mustard greens, arrowhead spinach, puntarelle, epazote, red watercress, Russian kale, scarlet butter lettuce, tat soi, upland cress, living watercress, broccolini, kale, read oak leaf, red salanova, sprouting broccoli, Chinese broccoli, zo broccoli rabe, green broccoli, Chinese spinach, mibuna, minutina, sweet pepper, ramsons, sprouting onion seeds, ‘little gem’ lettuce, ‘marvel of four seasons’ lettuce, ‘green frills’ mustard, gai choy mustard, land seaweed, Greek cress, summer savory, oriental radish (daikon), Chinese lettuce (Celtuce), fenugreek, Chinese cabbage (yow choy), napa cabbage, rainbow Swiss chard, specialty hot peppers, and Easter white eggplant.

Examples of herbs include rocket (rucola), sorrel, coriander, basil (common), basil (Thai), basil (lemon), Cayenne pepper, garlic chives, wild thyme, thyme (lemon),oregano, rosemary, thyme, chives, sage, cilantro, leaf radish, marjoram, lemon balm, Mache, chervil, dill, marjoram, sorrel, tarragon, ice plant, rhubarb, parsley, collard, celery, fennel, mache, tango, chervil, Italian parsley, rapini, Chinese parsley, green purslane, arugala ‘Giove’, basil (purple ruffles), lemon balm, lemon basil, and purple basil.

Examples of halophytes include samphire (glasswort), sea aster (spinach), salsola soda, sea beet, rock samphire, sea kale, New Zealand spinach, saltbush, and alexanders (smyrnium olusatrum).

Examples of medicinal plants include peppermint, lavender, anisi fructus, echinaceae purpureae, ephedra, holy basil, sage, stevia, valeriana officinalis, ginseng, Peruvian ginseng (Maca), daffodil, crambe, camellia, Russian dandelion, St. John's wort, blue cohosh, roman coriander, holy ghost, masterwort, female ginseng, stinging nettle, yerba mansa, bloodroot, and drumstick tree. In embodiments, the plants or plant species intended to be cultivated (and hence intended to grow or growing) in the plant cultivation system may be plants growing under the same or similar conditions, such as rucola and basil.

The term “continuous” with reference to cultivation of plants by means of a circulatory system, such as a conveyor, refers to the continuous advancement of the plants and/or the plant holding means, such as the benches, throughout the plant cultivation system; i.e., movement of the circulatory system is not discontinued during the cultivation of plants. The skilled person may appreciate that even in a continuously advancing cultivation system, the circulatory system may nonetheless be temporarily discontinued for plant handling actions, e.g., planting immature plants and/or harvesting mature plants. However, when no specific plant handling actions are required or performed, the circulatory system will typically be continued.

The term “batchwise” with reference to cultivation of plants by means of a circulatory system refers to refers to cultivation of plants, preferably in batches, without the continuous advancement of the plants and/or the plant holding means throughout the plant cultivation system; i.e., movement of the circulatory system is at least temporarily discontinued during the cultivation of plants. Specifically, the circulatory system may be at least temporarily discontinued during the providing of growing conditions suitable for cultivation immature plants into mature plants. It is understood that the temporary discontinuation of movement is in addition to stopping of the circulatory system for performing of specific plant handling actions. In some preferred embodiments, the system and method of the present disclosure may be configured for batchwise cultivation of plants. Specifically, the herein described system may be a system for the batchwise cultivation of plants, and/or the herein described method may be a method for the batchwise cultivation of plants.

The present disclosure in a first aspect relates to a system for the cultivation of plants; i.e., a plant cultivation system. The system may comprise:

a plurality of benches (such as at least four benches) for cultivating plants;

a rack comprising a pair of elongated rows, the rows being arranged one above the other, each row providing space for holding at least two benches;

a conveyor system comprising at least two endless conveyor chains and a conveyor drive means configured for driving said conveyor chains;

wherein the conveyor chains are arranged parallel to each other at opposite sides of the rack and wherein each conveyor chain extends longitudinally along the length of the rack; wherein the conveyor chains define a bench conveying path having a substantially horizontal portion running along one row, a substantially horizontal portion running along the other row, and two side portions connecting said substantially horizontal portions; and,

wherein each of the plurality of benches is pivotally attached to the conveyor chains such that each of the plurality of benches is conveyable along the bench conveying path.

The present disclosure in a further aspect relates to a system for cultivation of plants, comprising:

a plurality of benches for cultivating plants;

a rack comprising a pair of elongated rows, one arranged above the other; each row providing space for holding at least two benches and comprising means for providing growing conditions suitable for the cultivation of plants;

a conveyor system comprising at least two endless conveyor chains, arranged in a parallel manner on opposite sides of the rack and extending longitudinally along the length of the rack so as to define a bench conveying path having a substantially horizontal portion running along one row, a substantially horizontal portion running along the other row, and two side portions connecting said substantially horizontal portions; wherein every bench is pivotally attached to the conveyor chains and is conveyable along said bench conveying path;

characterised in that the system system comprises a conveyor drive for driving the conveyor chains, and a control unit operatively connected to said conveyor drive and configured for controlling the conveyor system to

convey the plurality of benches along the bench conveying path until at least one bench reaches a side portion, and then stopping said bench at a position along the side portion suitable for planting one or more immature plants and/or harvesting of mature plants; and,

convey the plurality of benches along the bench conveying path until every bench reaches a horizontal portion of the bench conveying path, and then stopping the benches at a position along the horizontal portions suitable for providing growing conditions until the immature plants develop into mature plants.

The bench may be a receptacle that has been adapted for holding plants such that plants can grow within said bench. Typically, the bench may have an elongated body with a substantially closed bottom for supporting the plants, a plurality e.g., four or more upright enclosing sidewalls, and a substantially open top. The open top may expose the foliage of growing plants to light and enable the exchange of gasses.

Each bench may be provided with one or more trays for holding the plants as described above. The tray may also be a receptacle that is adapted for holding plants in a way that the plants can grow within said tray. However, the tray may be smaller and optionally shallower compared to the bench, such that it can be fit into said bench. The provision of trays may allow dividing a bench into separate areas. Advantageously, the bench may be provided with a plurality of adjacently arranged trays. Similarly to the bench, there may be variations on the exact shape and dimensions of a tray without adversely affecting the functionality of the cultivating system. The advantage of using trays is that handling of plants becomes easier and more efficient. Also, maintenance of the bench becomes easier, because the trays can be cleaned, replaced, or repaired without having to change the entire content of the bench. Additionally, the bench or tray may be provided with a perforated lid with holes through which the plants can grow.

It is understood that there may be variations on the exact shape and dimensions of the benches without adversely affecting the functionality of the cultivating system. In an embodiment, a bench has a length of about 1.40 m (140 cm) to about 2.20 m (220 cm), such as a length of about 1.60 m (160 cm) to about 2.00 m (200 cm), preferably a length of about 1.90 m (190 cm). Advantageously, the length of the bench may correspond to the distance between the at least two conveyor chains, such that the bench can be easily attached thereto, as described in more detail below. In an embodiment, a bench has a width of about 40 cm to about 80 cm, such as a width of about 50 cm to about 70 cm, preferably a width of about 56 cm. In an embodiment, a bench has a height of about 5 cm to about 15 cm, such as a height of about 8 cm to about 12 cm, preferably a height of about 10 cm.

In an embodiment, a tray has dimensions (e.g., length, width, and height) corresponding with the dimensions of a bench. In an embodiment, a tray has a length of about 5 cm to about 1.10 m (110 cm), such as a length of about 10 cm to about 1.00 m (100 cm), preferably a length of about 55 cm. In an embodiment, a tray has a width of about 5 cm to about 80 cm, such as a width of about 20 cm to about 70 cm, preferably a width of about 31 cm. In an embodiment, a tray has a height of about 0.5 cm to about 10 cm, such as a height of about 3 cm to about 7 cm, preferably a height of about 5 cm. Advantageously, the dimensions of the trays are such that a combination of one or more trays, such as two, three, four, five, six or more trays, essentially corresponds to the dimensions of one bench.

The benches or trays can be constructed from different materials that may impact their durability, resistance, appearance, and functionality. Exemplary materials include wood, metal, fiberglass and polymers, with metal being a classical material of choice. Stainless steel may be regarded as a particularly well-suited material for the benches. Nonetheless, fiberglass or polymers have the advantage of being more lightweight. The skilled person is understood to be aware of the advantages and disadvantages for each material and the system and method of the present disclosure are by no means limited to a particular choice thereof.

Each bench or tray may receive a plurality of seeds, seedlings and/or plants of at least one plant species. Each bench or tray may also receive growth medium to support the growth of the received plants. The terms “growth medium” or “plant growth medium” as used herein refer to a substrate or medium for culturing plants. In certain embodiments, the growth medium may be soil, compost, peat, coco-coir, wood fibres, a soil-mimicking substrate such as mineral lava or basalt substrate, textile, or a soil-less substrate. The skilled person understands that different types of growth media may be used for growing different types of plants.

Additionally, each bench or tray may receive nutrient solution to promote the growth of plants in the growth medium. The terms “nutrient solution”, “mineral solution” or simply “solution” as used herein refer to an aqueous mixture wherein one or more nutrients such as minerals have been dissolved. The nutrient solution may for example be a liquid fertilizer. Nutrient solution may be delivered by means of a fluidic system, which is described further below. The skilled person understands that different types of nutrient solution may be used for growing different types of plants.

Each bench may be provided with a dispensing point to efficiently receive nutrient solution from the fluid delivery system. The dispensing point may be located at one side or both sides of the bench, so that the dispensing can be performed more efficiently. Preferably, the fluid dispensing point may be performed near the top the bench. The bench may also be provided with features (e.g., canals) to promote the delivery of nutrient solution from the delivery point to the roots of the plants. Optionally, the one or more trays are arranged in a way to promote the distribution of nutrient solution.

Each bench may also be provided with a draining point to efficiently drain excess or spent nutrient solution. The terms “draining point”, “drain” or “bench drain” may be used interchangeably herein. The draining point may be located at one side or both sides of the bench, so that the draining can be performed more efficiently. Preferably, the draining may be performed near the bottom the bench. The bench may also be provided with features (e.g., canals) to promote the draining of nutrient solution from the roots of the plants to the bench drain. Optionally, the one or more trays are arranged in a way to promote the draining of nutrient solution.

Each bench may be provided with a means for attaching said bench to at least two conveyor chains, which may be found discussed further below. Preferably, each bench may be provided with an attachment means at opposing ends of said bench, such that the bench may be simultaneously attached to the at least two conveyor chains arranged at opposite sides of the rack. Attachment of the bench to the at least two conveyors may be performed at the same time, or it may be performed in a stepwise manner, i.e., attachment to one conveyor after the other. The terms “conveyor attachment means” or “attachment means” can be used interchangeably herein.

Advantageously, the attachment means may be configured for pivotal attachment; i.e., the bench may be pivotally attached to the conveyor chains. The advantage of a pivotal attachment is that the bench may rotate or oscillate, at least to some degree, during the conveying such that the bottom of the bench can always remain oriented towards the ground surface, regardless of the conveying speed and direction. This configuration may thereby prevent tilting of the bench, especially when it is conveyed from one row to another, which could otherwise risk spilling or damaging the content of said bench.

In an embodiment, each bench may be reversibly attached to the conveyors. Preferably, the attachment means may be configured for reversible attachment; i.e., the bench may be attached to the conveyor chains and reversibly detached from said conveyor chains. This may allow for easier attaching of new benches and detaching of used benches. Also, this may allow for easier handling of plants in the benches by detaching the plant bench and performing the plant handling actions on a detached plant bench.

In an embodiment, the reversible attachment means may comprise a hook, i.e., a structure with curved back at an angle, which may be hooked around a complementary member, like a pin, bolt or lug, which may be provided on the conveyor chains. This embodiment may essentially enable a hanging of the attachable bench onto the conveyor chain. Preferably, the hook extends upwards from a sidewall of the bench. It may be provided with an elongated back portion to extend the distance between the conveyor chain and the bench. This may allow for easier attachment of the bench to the conveyor chains. Advantageously, the hook has an elongated neck portion to almost encircle the complementary member fully, such that it the attachment stays secure if the bench is tilted. The inventors found that the provision of a hook form is particularly well suited for providing a pivotal attachment while also ensuring an easy attachment and detachment of benches from the conveyor chains.

Accordingly, in an embodiment, each bench has opposing ends and comprises an attachment means, such as a hook, at each opposing end, and each conveyor chain comprises a transverse member, wherein the attachment means, such as the hooks, are hooked over the transverse members such that the bench is reversibly attached to the conveyor chains.

The rack provides a space for holding at least two of the above-described benches. Typically, the rack may be a framework comprising rails and bars that have been fixed in a way to form two or more elongated rows within said framework. The rack may also mechanically support cultivation devices such as a fluidic system, lighting devices, various sensors e.g., a carbon dioxide, temperature, humidity and/or air flow sensor.

The row provides space for holding at least two plant benches. The wordings “space for holding a plant bench”, “space for holding a bench” or “bench position” may be used interchangeably herein. The row may provide space for holding at least three, at least four, at least five, at least six, at least seven, at least eight, at least nine, at least ten, at least twelve, at least fourteen, at least sixteen, at least eighteen, or at least twenty plant benches. In embodiments, the row may comprise at least two bench positions. For example, the row may comprise at least three, at least four, at least five, at least six, at least seven, at least eight, at least nine, at least ten, at least twelve, at least fourteen, at least sixteen, at least eighteen, or at least twenty bench positions. The height and length of each row of the rack is adjusted to provide sufficient space for holding at least two benches; i.e., each row may hold at least two benches. The height of each row may be fixed, or it may be adjustable at least to an extent. Advantageously the height of each row is adjusted to provide sufficient space for plant growth; i.e., the plant may grow out of the bench without being impaired by the ceiling of the row or elements hanging therefrom. Advantageously, the at least two rows have substantially the same length such that they can provide the same conveying path length. Alternatively, at least one row may have a different length to provide a longer conveying path length and/or to provide space for cultivation devices or plant handling.

In an embodiment, the rack has a length of about 6.0 m to about 12.0 m, such as a length of about 9.0 m to about 11.5 m, preferably a length of about 11.0 m. In an embodiment, the rack has a width of about 1.60 m to about 2.40 m, such as a width of about 1.80 m to about 2.20 m, preferably width of about 2.10 m. In an embodiment, the rack has a height of about 30 cm to about 270 cm, such as a height of about 60 cm to about 250 cm. The size of the rack may correspond to the sum of its parts. Nonetheless, the size of the rack may be increased to provide additional space for additional rows or devices.

In an embodiment, at least one row has a length of about 6.0 m to about 12.0 m, such as a length of about 9.0 m to about 11.5 m, preferably a length of about 11.0 m. In an embodiment, at least one row has a width of about 1.60 m to about 2.40 m, such as a width of about 1.80 m to about 2.20 m, preferably a width of about 2.10 m. In an embodiment, at least one row has a height of 15 cm to about 95 cm, such as a height of about 30 cm to about 60 cm or of about 40 cm to about 50 cm, preferably a height of about 45 cm.

The at least two rows are preferably arranged one above the other, i.e., a first row may be arranged above a second row. These rows may be contiguous, such that the bottom of one row forms the top or ceiling of the other row. Alternatively, additional space may be provided between the at least two rows, which could be used to accommodate cultivation devices or necessary components thereof (e.g., electronic wiring).

The rack may be free standing, or it may be securely attached to the ground or some stationary object such as the housing, e.g., a shipping container. The rack can be constructed from different materials that can impact its durability, resistance, appearance, and functionality. Preferred construction materials include metals such as stainless steel. The skilled person is understood to be aware of the advantages and disadvantages for each material and the system and method of the present disclosure are by no means limited to a particular material.

The conveyor system may comprise at least two conveyor chains defining a continuous bench conveying path; i.e., movement of the conveyor chains conveys the benches along a conveying direction that forms a continuous loop between the at least two rows. The terms “convey”, “transport”, “move” “displace” may be used interchangeably herein and refer to carry an object (such as a bench as taught herein) from one place to another.

The conveying path may have a substantially horizontal portion running along one row, a substantially horizontal portion running along the other row, and two side conveying portions connecting said substantially horizontal portions. The two side conveying portions may be substantially vertical portions, typically forming an arc-shaped path as a result of the circular shaped drive means. The summation of the listed conveying paths forms an essentially endless loop between the at least two rows, whereby when a bench reaches the end of one row, for example a first row, it can continue at the start of the other row, for example a second row, and vice versa. The inventors have found that this configuration provides a particularly efficient use of space and resources since the available rack space can be filled with benches without necessary provision of user access thereto.

Typically, the at least two conveyor chains may be roller chains that can be driven by a conveyor drive means, as described further below. The conveyor chains may be constructed from different materials that can impact its durability, resistance, appearance, and functionality. Preferred construction materials include metals such as stainless steel, which is particularly well suited to the displacement of heavy loads and the wear-resistance to hold-up over time without seizing due to deformation.

The conveyor chains may be arranged parallel to each other at opposite sides of the rack. This configuration allows a bench to be attached simultaneously at both ends of said bench so that the bench may be uniformly conveyed by said oppositely arranged conveyors chains. Preferably, the conveyor chains are disposed at the same corresponding heights at each side of the rack.

The conveyor chains may be arranged to extend in the longitudinal direction of each row of the rack; i.e., the conveyor chains extend longitudinally substantially along the length of the rack. This configuration may enable the conveyor chains to form the above-described conveying path in the longitudinal direction of the elongated rows. Specifically, each conveyor chain may have a portion extending substantially horizontally along one row, a portion extending substantially horizontally along the other row, and two side portions connecting said horizontally extending portions. The two side portions may extend substantially vertically, optionally with a curved portion arranged along a circular shaped drive means.

In an embodiment, at least one chain has a length of about 10.0 m to about 25.0 m, such as a length of about 11.0 m to about 24.0 m, preferably a length of about 23.0 m. The length of one chain is preferably adjusted to the length of the rows such that the chain may extend substantially over their entire length.

In an embodiment, the conveyor chains may comprise a transverse member arranged transverse to the conveying direction of the conveyor chains. In an embodiment, the conveyor chains may comprise a transverse member suitable for hooking, like a pin, bolt, or lug with a curved surface, which allows a complementary hook provided on an attachable bench to be hooked over. Preferably, the transverse member is horizontally aligned. Preferably, the transverse member extends inwards into the row. This may allow for easier attachment of the bench to the conveyor chains. The end of the transverse member may be provided with a flattened or thickened portion, to lock the sideways movement of an attachment means such as hook. A plurality of transverse members may be provided along the conveyor chain, at least one for each bench to be attached. The transverse members may be mounted onto the chain, or parts of the conveyor chain may be interrupted with plates that are provided with a transverse member, or a combination of both. In an embodiment, a plurality of transverse members may be provided at regularly spaced intervals along the conveyor chain. The distance of the regularly spaced intervals is such that the number of benches spaced along the conveyor chain may be optimized.

The conveyor system may also comprise a conveyor drive means for driving the above-described conveyor chains. The conveyor drive means or simply conveyor drive may comprise a rotary actuator coupled to a motor adapted for providing a rotating motion. This way the rotating motion can be mechanically converted into a linear movement of the conveyor chains. The motor may be any type of motor but is preferably an electric motor to prevent emission of exhaust gas into the controlled environment.

In an embodiment, the conveyor drive means comprises at least two rotary actuators, wherein the at least two rotary actuators are arranged for driving the at least two conveyor chains. The rotary actuator may comprise one or more sprockets, i.e., profiled sprocket-wheels with teeth. The sprockets may be driven by a drive chain indirectly connecting the sprocket to a rotary motor. Advantageously, the drive means of a single conveyor chain may comprise at least two sprockets provided at each end of the rows. This configuration allows the sprockets to form the side portion of the conveying path and provide mechanical stability to the system. Typically driving the motion of a single sprocket is sufficient for moving the conveying chains, but if needed each sprocket may be individually driven by a dedicated motor. The skilled person understands that the configuration may further include or be replaced with other components commonly used in the art, such as profiled cogs.

Further, each conveyor chain may be driven by a separate drive means. This configuration has the advantage that less powerful motors may be required. Preferably, the at least two conveyor chains may be driven by a common drive means. This configuration has the advantage that a synchronized conveying motion is ensured between the oppositely arranged conveyor chains and the complexity of the system may also be reduced. The latter configuration may be achieved by, for example, mechanically connecting two sprockets from each conveyor chain assembly, i.e., one sprocket from a first conveyor chain assembly to another sprocket from a second conveyor chain assembly. Preferably, the at least two rotary actuators are rotatably coupled by a common drive shaft, which may be connected to at least one sprocket from each conveyor chain assembly, i.e., one sprocket from a first conveyor chain assembly and a second sprocket from a second conveyor chain assembly, by means of at least two drive chains.

In a preferred embodiment, the drive means may comprise a common drive shaft arranged between two oppositely arranged drive sprockets, each drive sprocket being configured for driving a different conveyor chain. The common drive shaft may be driven by a single motor, for example by a drive chain connecting said shaft to a rotating motor, or alternatively, one of the at least two sprockets may be directly driven by a rotating motor and transfer the rotating motion of said sprocket onto the other sprocket through a mechanical connection.

The conveyor system may comprise a plurality of rotatably mounted rollers. The rollers may be arranged in the transverse direction of each row of said rack; i.e., the rollers chains may be arranged perpendicular to the longitudinal direction of each row. Each roller may comprise a roller body, which is rotatably mounted to a stationary roller shaft mounted in the rack. The roller body may preferably be cylindrical or have a curved surface. The plurality of rollers may be adjacently arranged to form a near continuous surface that can support the bottom of the plurality of benches. This configuration may allow a rolling of the benches over the rollers during conveying, such that the weight of the benches can be supported by the rack when the benches are stopped (no conveying motion), while also reducing friction when the bench are conveyed along the row. This may alleviate pressure from the conveyor chains, which can extend the lifetime of the present system. The rollers may extend over 1% to 100% of the length of the row, preferably 10% to 90%, or 20% to 80%, or 30% to 70%, or 40% to 60% of the length of the row. Additionally, the rollers may be conveyor rollers that can be driven by a driving means to convey the benches along the bench conveying path, thereby further supporting the conveyor chains. The conveying speed would preferably be synchronised between the conveyor chains and the conveyor rollers.

In order to conserve resources, the conveying of benches may be purposely limited to when one or more selected benches should reach a specific position along the conveying path, for example for handling and/or cultivating of plants contained in said selected benches. During normal operation of the system, however, the benches can remain stationary, i.e., the benches are not conveying. Preferably, each bench of the plurality benches may remain stationary at a horizontal portion of the bench conveying path. For this configuration, the conveyor system may be adapted to be controllable; i.e., it is a controllable conveyor system.

For this purpose, the conveyor system may comprise a conveyor control unit that is operatively connected to the drive means of said conveyor system. Specifically, the conveyor control unit may control the motor driving the actuator of the conveyor chains and/or conveyor rollers, or alternatively, to a moveable mechanical connection adapted to transfer the work provided by the motor to the actuator of the conveyor chains and/or conveyor rollers. This way the control unit may be configured to control the conveying motion, conveying direction and/or conveying speed of the conveyor system. The conveyor system may be configured for a continuous conveying of benches along the entire bench conveying path, or a purposed conveying of benches along a predetermined portion of the bench conveying path.

The conveyor control unit may be configured to control the conveyor system responsive to manual input from a user, like an operator, or may be automated, at least to an extent, by receiving input from one or more operatively connected cultivating systems, which are described further below, or both.

In a first example the conveyor control unit may receive a start signal from a user, which activates the conveyor system to start conveying of benches along the bench conveying path until a stop signal is received from said user. This way manual control of the conveying system can be achieved.

In a second example the conveyor control unit may receive a start signal from a control system, which has been programmed to perform an irrigation of the benches. The conveyor system will start conveying of benches along the bench conveying path until at least one bench arrives at a position suitable for irrigation, which may then trigger a stop signal. The stop signal may be triggered by input from a sensor or can be determined by tracking of the bench movement. The control system may then provide instructions to a fluidic system to initiate irrigation. This way automated control of the conveying system can be achieved.

The conveyor control unit may be preprogrammed with a number of stop positions. Exemplary programming of stop positions is listed below. It is, however, understood that the conveyor control unit may be easily programmed with other stop positions.

Handling programming: This programming may include a conveying of the plurality of benches along the bench conveying path until a designated bench, in particular a bench containing a plant requiring a handling action, reaches a side portion of the bench conveying path, and then stopping the conveying of benches such that said designated bench is positioned at the side portion of the conveying path. This programming may result in the designated bench to stick out between the rows, which may allow easier access to the designated bench by an operator.

Maintenance programming: This programming may include a conveying of the plurality of benches along the bench conveying path until a designated bench, in particular a bench containing a plant requiring a maintenance action, reaches a side portion of the bench conveying path, and then stopping the conveying of benches such that said designated bench is positioned at the side portion of the conveying path. This programming may result in the designated bench to stick out between the rows, which may allow easier access to the designated bench by an operator.

Cultivating programming: This programming may include a conveying of the plurality of benches along the bench conveying path until each bench of the plurality benches reaches a horizontal portion of the bench conveying path, and then stopping the conveying of benches such that all benches are disposed along the rows. Most if not all cultivating systems, such as the lighting system, may be arranged along the horizontal portion of the bench conveying path, so this programming may allow for cultivating of the plants. Moreover, it may also prevent any benches from sticking out between the rows, which could strain the conveyor chain.

Irrigation programming: This programming may include a conveying of the plurality of benches along the bench conveying path until one or more designated benches reach a horizontal portion of the conveying path that aligns with the position of one or more irrigation zones and then stopping the conveying of benches such that the one or more designated benches aligns with one or more devices of the fluidic system. In particular, the bench may align with a tube from a fluid dispensing system and a gutter from a fluid draining system. This position may then enable the fluidic system to irrigate said bench.

Emergency programming: This programming may include a stopping of the conveying of the plurality of benches when an emergency stop signal is received by an operator or a monitoring system.

In an embodiment, the conveyor system is configured for:

stopping the conveying of benches along the bench conveying path when at least one bench is positioned at a side portion of the bench conveying path, and

stopping the conveying of benches along the bench conveying path when all benches (i.e., the at least four benches) are positioned at a horizontal portion of the bench conveying path.

The conveyor control unit may be configured to control the conveying direction of the conveyor chains, i.e., forward or backward along the horizontal portions, and downward or upward along the side portions. During a normal operation of the present system the conveying of benches will proceed in a predetermined standard direction. The standard direction may be determined depending on the orientation of the system towards or away from the operator area. Preferably, the standard direction involves a movement away from the operator area on the upper row, a downward movement, a movement towards the operator area on the lower row, and an upward movement at the side of the operator area. Nonetheless, if the conveyor system receives input that selected bench is to be conveyed to a specific position, which would require a near complete rotation of all benches, the conveying direction may be reversed to allow said selected bench to reach said specific position faster. The conveyor control unit may be configured for automatically determining the optimal conveying direction. The flexibility of having different conveying directions provides for a more efficient use of resources and time.

The conveyor control unit may be configured to control the conveying speed of the conveyor chains. During a normal operation of the present system the conveying of benches will proceed at a predetermined standard speed. The standard speed may be determined depending on the weight of the bench to prevent any risk of tilting thereof. Nonetheless, if the conveyor control unit receives input that a selected bench is to more urgently be conveyed to a specific position, the conveying speed may be increased accordingly. In an embodiment, the conveying speed may range from 0 m/s to 1 m/s, such as 0.1 m/s to 0.5 m/s, preferably 0.2 m/s.

As indicated above, the key growing conditions that plants require are temperature, ventilation, humidity light, water, nutrients, and carbon dioxide. The system and method of the present disclosure may also provide improved systems for controlling of one or more plant growing conditions. Specifically, the system and method of the present disclosure may comprise one or more devices configured to adjust one or more cultivation parameters that correspond to one or more growing conditions with the aim of supporting the growth of specific plant species and/or specific plants at different stages of growth. Adjustments to cultivation parameters may, for example, include adjustments to the nutrient solution (e.g., nutrient concentration or pH), the temperature, the air humidity, the light spectrum, the light intensity, the carbon dioxide concentration, the oxygen concentration, the air flow, the air pressure, etc. Preferred embodiments of systems for controlling plant growing conditions may be found discussed below. It is understood that any preferred embodiments of the growing conditions systems as described herein are also preferred embodiments of the plant cultivation system.

The plant cultivation system may comprise a lighting system configured for providing light suitable for the cultivation of plants. Specifically, the lighting system allows generating light that can be absorbed by the foliage of growing plants and sprouts. The lighting system may comprise a plurality of lamps configured for generating and subsequently emitting light within a wavelength suitable for the growing of plants. Preferably the lighting system is an electric lighting system, which may be understood to also comprise equipment known in the art for operating such technology, such as electrical wiring, power supply, sockets, amplifiers, isolators, various control, safety modules, and so on.

The lighting system may comprise one or more stationary lamps mounted on the ceiling of each row in the rack. The lamps may be arranged in the transverse or longitudinal direction of each row. Preferably the lamps are arranged in the transverse direction of each row. In other words, the rack may define a longitudinal axis, and the lamps may be arranged perpendicular to the longitudinal axis. Preferably a plurality of lamps is arranged with an adjusted distance between each lamp to ensure that the bottom of a row of the rack may be entirely illuminated. This way the occurrence of dark spots along the conveying path may be reduced. In an embodiment, the distance between two lamps may be 10 cm to 30 cm, such as 15 cm to 25 cm, preferably the distance between to lamps may be 20 cm. Advantageously, the lamps are arranged directly above the bench conveying path, such that they can radiate directly on the plants below, thereby reducing potential energy losses. The lamps may be mounted to the ceiling by means of a fastening element, such as screws or clips. Use of clips may be preferred because they allow for easier exchange of the lamp in case of a malfunction.

The lighting system may comprise at least one retractable lamp. The lighting system may comprise at least one retractable lamp configured to retract (i.e., move inside the rack) when a bench passes a side portion of the bench conveying path. The lighting system may comprise at least one retractable lamp (e.g., LED lamp) configured to retract during the conveying of benches along the bench conveying path. Preferably, the at least one retractable lamp is arranged at (each of) the ends of each row of the plant cultivation system. Such lighting system comprising at least one retractable lamp advantageously allows conveying of the plant benches along the bench conveying path without collision of the plant benches with the lighting system when the plant benches pass the side portions of the bench conveying path. When conveying is stopped and the plant benches are in the rows for cultivating of the plants, the retractable lamp can move back outwards. In this way, the entire space of the row including the positions at the ends of the rows can be used for cultivating plants, thereby optimizing space usage and efficiency of the plant cultivation system.

In embodiments, the plant cultivation system as taught herein may comprise a lighting system comprising at least one retractable lamp configured to retract during the conveying of benches along the bench conveying path, the at least one retractable lamp being arranged at the ends of each row. In embodiments, the at least one retractable lamp may be arranged above the bench position located at an end of a row, preferably above the bench position located at (each of) the ends of each row.

The retractable lamp may be mounted on a moveably arranged shaft. The movement of the moveably arranged shaft can be driven by means of a linear actuator coupled to a motor adapted for providing a linear motion. For example, the linear actuator may be a piston driven by a pneumatic control valve. Compression of the piston may essentially allow for retracting a lamp mounted on the shaft. Preferably, the shaft is provided with a plurality of lamps, for example two or three lamps, that are mounted to said moveably arranged shaft by means of a fastening element, such as screws or clips. The retractable lamp may be arranged on the ceiling near the edge of at least one row such that the lamp may extend outwards from the rack. This configuration may allow retracting of the lamp mounted thereon when a bench is conveyed along a side portion of the bench conveying path, such that collision with a bench (or plants growing out of said bench) may be avoided. Once this bench has passed the side portion of the bench conveying path (e.g., once conveying has stopped and the plant benches are positioned in the rows), the retracted lamp may be extended outwards again. This has the advantage that the amount of available plant growth space may be increased.

Advantageously, control of the retracting/extending functionality is synchronised with control of the conveying system, such that the retractable lamp is automatically retracted during the conveying of benches. Advantageously the retractable lamp is directly or indirectly controlled by the herein described control unit. The retractable lamp may be retracted when a bench moves along a side portion of the bench conveying path and subsequently automatically extended when said bench has passed this side portion. Preferably, the retractable lamp may be retracted during any conveying of the benches and is only extended once the conveying is fully stopped, for example at an irrigation or cultivating stop position.

In an embodiment, the lighting system may comprise one or more retractable lamps, such as two or more, three or more, or four or more retractable lamps, arranged at each opposite end of said row. In other words, the lighting system may comprise at least two retractable lamps per row, each retractable lamp being arranged at opposite ends of said row. Preferably, the lighting system may comprise at least eight retractable lamps per row, e.g., may comprise at least four retractable lamps arranged at each opposite end of said row.

Advantageously, the lighting system may allow an adjustment to one or more light parameters including but not limited to the light intensity (e.g., dimmable), the light spectrum (e.g., color and correlated color temperature), light times (e.g., duration on/off) and/or the reflected light beam angle. Preferably, lighting system may comprise a light diffuser adapted for homogenizing the light. Also, adjustment of the lighting time may allow for simulating a day-night cycle or seasonal changes. Adjustment of light parameters responsive to the growth cycle of the plants may promote growth and/or increase yields. For example, the photosynthetic processes of different plants species may saturate at different light intensities. Matching the light intensity by which plants of a specific plant species are irradiated with the light intensity at which photosynthetic processes for that plant species saturate may increase yields in an energy-efficient way.

In an embodiment the system may comprise a lighting control unit that adjust one or more light parameters to suit the specific needs of one or more plants contained in the plant benches. For example, the lighting control may track the position of one or more plant type, preferably by tracking the position of the corresponding plant benches along the bench conveying path, and adjusting the light parameters to the specific plant type. Additionally, or alternatively, the lighting control unit may track the growth of one or more immature plants, preferably by tracking the position of the corresponding plant benches along the bench conveying path, and adjusting the light parameters to the plant growth, for example the immature plant age. For example, the lighting control may receive a user input about which plant type is provided in the corresponding plant bench and/or the time at which the immature plant is planted. Advantageously the lighting control unit is connected to the herein described control unit or is part thereof.

Light parameter adjustment may be kept homogenous across the system; i.e., all operational lamps emit light having the same light parameters. However, the light parameters may also be varied to divide the system into two or more lighting zones. For example, the light parameters may be adjusted per row, or each row may be further subdivided into different zones.

The provision of lighting zones may allow for concurrently growing plants belonging to more than one plant species. This may enhance the versatility of the present system. Additionally, or alternatively, of lighting zones may also be optimised to the growth stage of the plants and its nutritional requirements. This may enhance the efficiency of the present system.

Preferably the lighting system is a light-emitting diode (LED) based lighting system; i.e., the lamps of said system generate light by means of LED technology. As such, the LED-based lighting system may be understood to also comprise equipment known in the art for operating such technology; in particular the above-described lighting system may be an arrangement of LED lamps. The inventors have found that LED technology is particularly well suited for indoor growing purposes. The LED-based lighting system may comprise a UV LED, a blue LED, a green LED, and/or a red LED. In one or more embodiments, the LED may be configured for generating and subsequently emitting light within a specific wavelength, in particular:

UV LED may generate light having a wavelength of at least 100 nm to at most 400 nm; preferably having a wavelength of at least 315 nm to at most 400 nm (UVA), a wavelength of at least 280 nm to at most 315 nm (UVB), and/or a wavelength of at least 100 nm to at most 280 nm (UVC);

Blue LED may generate light having a wavelength of at least 400 nm to at most 500 nm (Blue);

Blue LED provided with a specific coating (e.g., phosphor-coated blue LED) may emit light having a wavelength of at least 400 nm to at most 1000 nm (White).

Green LED may generate light having a wavelength of at least 500 nm to at most 600 nm (Green);

Red LED may generate light having a wavelength of at least 600 nm to at most 700 nm (Red) and/or a wavelength of at least 700 nm to at most 800 nm (Far-Red); and/or

the above-listed LEDs may be combined to generate one or more lights having specific wavelengths of choice.

It is understood that the LED-based lighting device may allow adjusting of one or more lighting parameters by adjusting the operating conditions of the LEDs, e.g., adjustments to voltage and/or current.

The plant cultivation system may comprise a fluidic system configured for providing fluid suitable for the cultivation of plants. Specifically, the fluidic system may allow dispensing of nutrient solution to the roots of plants, and optionally also for draining excess or spent nutrient solution. The fluidic system may comprise a fluid dispensing system, which may be understood to also comprise equipment known in the art for operating such technology, such as tubing, tube fittings, valves, reservoirs, filters, counters, and so on. The terms “fluid dispensing system” or “fluid delivery system” may be used interchangeably herein. The fluidic system may also comprise a fluid draining system, which may be understood to also comprise equipment known in the art for operating such technology, such as benches, gullies, drains, tube fittings, valves, reservoirs, filters, counters, and so on. The fluidic system may be arranged to form one or more irrigation zones, which is discussed further below.

The cycle of dispensing and subsequently draining fluid may be referred to as irrigation; the combination of the fluid dispensing system and the fluid draining system may thus also be referred to as the irrigation system. Advantageously the fluidic system may also comprise a fluid recycling system for recycling spent nutrient solution, which may be gathered by means of the fluid draining system. Preferably, the fluidic system is adapted for recirculating all liquids, filtering and re-using them.

The nutrient solution may comprise nutrients and has a pH. The nutrient solution may, for example, contain one or more of the following nutrients: nitrogen, phosphorous, potassium, calcium, magnesium, iron, sulphur, manganese, boron, copper, zink, molibdemo, silica and sodium. Preferably the fluidic system may be configured for controlling the nutrient concentration in the delivered solution. Also, the fluidic system may be configured for controlling the pH and/or the dissolved oxygen concentration in the nutrient solution. Furthermore, the use of a controllable mineral supply, dissolved oxygen supply and pH regulator allows controlling the supply of nutrients, whereby the supply of nutrients is preferably adapted to the nutrient uptake of the plants being grown in the benches. Moreover, nutrient control under different plant developmental stages may provide flexibility for responding in an efficient way to plant needs.

This may result in better yields by providing the necessary nutrients that the plants need to grow with a correct water/nutrient management.

In an embodiment the system may comprise a fluidic control unit that adjust the dispensing of fluid, optionally by adjusting the content of the nutrient solution, to suit the specific needs of one or more plants contained in the plant benches. For example, the fluidic control may track the position of one or more plant type, preferably by tracking the position of the corresponding plant benches along the bench conveying path, and adjusting the dispensing of fluid provided by the fluidic system to the specific plant type. Additionally, or alternatively, the fluidic control unit may track the growth of one or more immature plants, preferably by tracking the position of the corresponding plant benches along the bench conveying path, and adjusting the dispensing of fluid provided by the fluidic system to the plant growth, for example the immature plant age. For example, the fluidic control may receive a user input about which plant type is provided in the corresponding plant bench and/or the time at which the immature plant is planted. Advantageously the fluidic control unit is connected to the herein described control unit or is part thereof.

In embodiments, the plant cultivation system as taught herein comprising a fluidic system, said fluidic system comprising at least one fluid dispensing tube for dispensing fluid into the bench and at least one gutter for draining the dispensed fluid; and optionally, at least one bench drain spout for guiding the dispensed fluid from the bench into the gutter.

The fluidic system, in particular the fluid dispensing system, may comprise one or more tubes for dispensing fluid e.g., nutrient solution. The tubes may have a common outlet from which a constant flow of fluid is provided, or they may be provided with a dripper to reduce the flow of fluid by allowing the fluid to drip slowly to the roots of plants. The dispensing of fluid may be provided from above the soil surface or may be provided directly into the root zone, in which case the bench may be provided with features e.g., canals to promote its delivery to the roots of the plants. The nutrient solution may be intermittently delivered at specific time intervals depending on the plant requirements, for example, hourly, daily, weekly, and so on.

The fluidic system, in particular the fluid dispensing system, may comprise a plurality of fluid dispensing tubes having an outlet arranged along the side and/or the ceiling of at least one row. Advantageously, a number of fluid dispensing tubes may be arranged into fluid dispensing groups, which thus comprises a number of tubes per bench. Each fluid dispensing group may preferably be arranged at position where a bench may be stopped between conveying positions. This may reduce the amount of tubing and allow for more efficient irrigation of each bench. The number of tubes in each fluid dispensing group may for example vary from 1 to 10 or more. In an embodiment, each fluid dispensing may comprise 1 tube to 10 tubes, preferably 2 to 8 tubes, or 3 to 7 tubes, or 4 to 6 tubes, such as 5 tubes.

The fluidic system may comprise at least one retractable fluid dispensing tube. The fluidic system may comprise at least one retractable fluid dispensing tube configured to retract when a bench passes a side portion of the bench conveying path. The fluidic system may comprise at least one retractable fluid dispensing tube configured to retract during the conveying of benches along the bench conveying path. Preferably, the at least one fluid dispensing tube is arranged at (each of) the ends of each row of the plant cultivation system. Such fluidic system comprising at least one retractable fluid dispensing tube advantageously allows conveying of the plant benches along the bench conveying path without collision of the plant benches with the fluidic system when the plant benches pass the side portions of the bench conveying path. When conveying is stopped and the plant benches are in the rows for cultivating of the plants, the retractable fluid dispensing tube can move back outwards. In this way, the entire space of the row including the positions at the end of the rows can be used for cultivating plants, thereby optimizing space usage and efficiency of the plant cultivation system.

In embodiments, the at least one retractable fluid dispensing tube may be arranged above the bench position located at an end of a row, preferably above the bench position located at each end of each row.

At least part of the fluid dispensing tubes may be retractable. The retractable tubes may be mounted on a moveably arranged shaft, such as moveably arranged shaft whose movement can be driven by means of a linear actuator coupled to a motor providing linear motion or, alternatively, by means of a rotatable actuator coupled to a motor providing rotary motion. The retracting motion may include a retracting of at least a part of the tubing but may also be limited to retracting of the tube outlet only. Preferably retracting of tubes in a single dispensing group is synchronised. This configuration may allow retracting of the dispensing tube mounted thereon when a bench is conveyed along a horizontal portion of the bench conveying path, such that collision with a bench (or plants growing out of said bench) may be avoided. Once this bench has passed the horizontal portion of the bench conveying path, the retracted tube may be extended outwards again.

Advantageously, control of the retractable tube is synchronised with control of the conveying system, such that the retractable tube is automatically retracted during the conveying of benches. Advantageously the retractable tube is directly or indirectly controlled by the herein described control unit. The retractable tube may be retracted when a bench moves along a side portion of the bench conveying path and subsequently automatically extended when said bench has passed this side portion. Preferably, the retractable tube may be retracted during any conveying of the benches and is only extended once the conveying is fully stopped, for example at an irrigation or cultivating stop position. Preferably, the retractable tube may be extended only when a dispensing of fluid is to be provided and remains retracted otherwise. This may prevent the actuator from constantly being actuated, thereby improving the lifetime of the system.

The outlets of the fluid dispensing tubes may be arranged in a way that ensures fluid dispensing into the benches to avoid spillage. Each bench may be provided with a dispensing point from which the dispensed fluid may spread to the remainder of the bench. The bench dispensing point may preferably be situated at one side of the bench which will be aligned with the position of a fluid dispensing tube. Alternatively, two bench dispensing points may be provided, one on each side of the bench. This alternative configuration may allow for dispensing fluid from different sides, for example different compositions of the growth medium. Advantageously, the bench may be provided with features (e.g., canals) to promote the spreading of dispensed fluid throughout the bench volume.

The fluid draining system may comprise one or more gutters for draining dispensed fluid e.g., excess or spent growth medium. The gutter may be arranged to extend in the longitudinal direction of each row of the rack; i.e., the gutter extends longitudinally along the length or part of the length of each row. The length of the gutter may be typically adjusted to the length of the irrigation zone. For example, if irrigation of the benches is only provided along a half of a row, the gutter may only extend longitudinally along the half the length of said row. The gutter may be disposed at a slight slope such that the collected fluid may be carried to a side from which it can then be transferred to a fluid recycling system. The side may be provided with a downspout to guide the drained fluid to a lower level.

Preferably, the gutter may be arranged adjacent to conveying path of the benches, such that fluid can be collected from a drain of the bench. The bench drain may preferably be situated at one side of the bench which will be aligned with the position of a gutter. Alternatively, two bench drains may be provided, one on each side of the bench. This alternative configuration may allow for draining fluid from different sides. Advantageously, the bench may be provided with features e.g., canals to promote the draining of excess or spent fluid from the bench volume.

The fluid draining system may comprise one or more bench drain spouts for guiding drained dispensed fluid from the bench into the gutter. Preferably, the one or more bench drain spouts are retractable spouts configured to retract (i.e., move inside the rack) during the conveying of benches. The bench drain spouts may be retracted when a bench passes a side portion of the bench conveying path.

At least part of the bench drain spouts may be retractable. The retractable spouts may be mounted on a moveably arranged shaft, such as moveably arranged shaft whose movement can be driven by means of a linear actuator coupled to a motor providing linear motion or, alternatively, by means of a rotatable actuator coupled to a motor providing rotary motion. The retracting motion may include a retracting of at least a part of the spout body but may also be limited to retracting of the spout inlet only.

Advantageously, control of the retractable spout is synchronised with movement of the conveying system, such that the retractable spout is automatically retracted during the conveying of benches. The retractable spout may be retracted when a bench moves along a horizontal portion of the bench conveying path and subsequently automatically extended when said bench has passed this horizontal portion. Preferably, the retractable spout may be retracted during any conveying of the benches and is only extended once the conveying is fully stopped, for example at an irrigation or cultivating stop position. Preferably, the retractable spout may be extended only when a draining of fluid is to be provided (e.g., during fluid dispensing), and may remain retracted otherwise. This may prevent the actuator from constantly being actuated, thereby improving the lifetime of the system.

Advantageously, control of the retractable spout is synchronised with the retracting/extending of one or more retractable fluid dispensing tubes, such that such that the retractable spout is automatically retracted/extended with a corresponding dispensing tube to enable irrigation of the bench. This may reduce the complexity of the system.

The fluidic system may be arranged to provide for irrigation across the entire length of at least one row. Specifically, the above-described fluid dispensing and draining systems may be provided across the entire length of at least one row. In other words, the fluidic system may comprise one or more irrigation zones along the horizontal portions of the bench conveying path. This configuration may allow for irrigation of plant regardless of their position in the system. It may be advantageous for growing of plants requiring regular or larger amounts of growth medium provision.

The fluidic system may be arranged to form or may comprise one or more irrigation zones. Specifically, the length of the dispensing zone (i.e., corresponding to location of the fluid dispensing tubes) and/or the length of the draining zone (i.e., corresponding to the length of the gutter and optionally the location of bench drain spouts) may be limited to one or more sections or bench positions of the system. Benches requiring growth medium may be conveyed along the bench conveying path to reach an irrigation zone. This configuration may allow for limiting the necessary devices and piping, which may reduce the complexity of the system. Also, maintenance can be made more efficient and user-friendly.

In embodiments, the fluidic system may comprise an irrigation zone, wherein the irrigation zone may be arranged along the length of one or more bench positions of the row but not at (i.e., with the exception of) the bench position at the ends of each row. It will be understood that such irrigation zone will only be present in a plant cultivation system as taught herein when each row comprises at least three bench locations. In embodiments, when each row comprises at least three bench positions, the fluidic system may comprise an irrigation zone, wherein the irrigation zone may be arranged along the length of one or more bench positions of the row but not at (i.e., with the exception of) the bench position at the ends of each row. Accordingly, in embodiments, the plant cultivation system as taught herein may comprise a fluidic system, wherein the fluidic system may comprise at least one retractable fluid dispensing tube configured to retract during the conveying of benches along the bench conveying path, wherein the at least one fluid dispensing tube is arranged at the ends of each row, or the fluidic system may comprise an irrigation zone, wherein the irrigation zone may be arranged along the length of one or more bench positions of the row but not at (i.e. with the exception of) the bench position at the ends of each row. Plant cultivation systems comprising such fluidic systems advantageously allow conveying of the plant benches along the bench conveying path without collision of the plant benches with the fluidic system, such as the fluid dispensing tubes, when the plant benches pass the side portions of the bench conveying path.

The irrigation zones may be limited to a single row, for example, wherein one row is provided with one or more irrigation zones and the other row is not provided with an irrigation zone. Preferably, the irrigation zones are divided amongst the at least two rows. For example, in an embodiment wherein the fluidic system is arranged to form four irrigation zones amongst two rows, each row may be provided with two irrigation zones.

The length of the dispensing zone and the length of the draining zone may be kept constant in a single irrigation zone. In this configuration fluid may be provided to the benches aligned with the irrigation zone, after which time may be allowed to pass sufficient for preferably completely draining the benches. Once the benches are drained, the system may initiate conveying of the benches to a further position so that new benches may be irrigated and drained.

The length of the dispensing zone and the length of the draining zone may be varied in a single irrigation zone. Preferably, the length of the dispensing zone may be shorter than the length of the draining zone. In this configuration fluid may be provided to the benches aligned with the dispensing zone. However, these irrigated benches may be immediately moved further along the bench conveying path for as long as they remain within the length of the draining zone. This may allow for the fluids to be drained from the previously irrigated benches while new benches are being irrigated in the dispensing zone. Compared to the previous embodiment, this may reduce or even eliminate the system downtimes between the dispensing and draining of fluid and as such improve the efficiency of the system.

It is understood that the length of the dispensing zone and the length of the draining zone may be kept constant in a first irrigation zone but may be varied in a further irrigation zone. As such, both the above-described configurations may be combined to form different irrigation zones, for example between different rows.

The irrigation zones may be arranged to form an interconnected irrigation system. Preferably, the irrigation zones of each row are arranged on top of each other so as to form an at least partially overlapping irrigation zones. In embodiments, the irrigation zone of a first (upper) row is arranged above the irrigation zone of a second (lower) row. For example, whereby the irrigation zone of a first (upper) row is arranged at the start of said row and the irrigation zone of a second (lower) row is arranged at the end of said row. This configuration may allow for further limiting the necessary devices and piping, which may further reduce the complexity of the system. Preferably, the gutters of the connected irrigation zones may be connected by having the lower end of a downspout of a first gutter (from an upper row) end inside a second gutter (from an upper row), such that the fluid from the first gutter can be drained by the second gutter. In embodiments, the plant cultivation system as taught herein may comprise a lighting system as taught herein, and a fluidic system as taught herein.

Accordingly, an aspect relates to a system for the cultivation of plants, comprising:

a plurality of benches for cultivating plants;

a rack comprising a pair of elongated rows, the rows being arranged one above the other, each row providing space for holding at least two benches;

a conveyor system comprising at least two endless conveyor chains and a conveyor drive means configured for driving said conveyor chains;

a lighting system comprising at least one retractable lamp configured to retract during the conveying of benches along the bench conveying path, the at least one retractable lamp being arranged at the ends of each row; and

a fluidic system, wherein the fluidic system comprises at least one retractable fluid dispensing tube configured to retract during the conveying of benches along the bench conveying path, the at least one retractable fluid dispensing tube being arranged at the ends of each row; or wherein the fluidic system comprises an irrigation zone, wherein the irrigation zone is arranged along the length of one or more bench positions of the row but not at the bench position at the ends of each row;

wherein the conveyor chains are arranged parallel to each other at opposite sides of the rack and wherein each conveyor chain extends longitudinally along the length of the rack; wherein the conveyor chains define a bench conveying path having a substantially horizontal portion running along one row, a substantially horizontal portion running along the other row, and two side portions connecting said substantially horizontal portions; and wherein each of the plurality of benches is pivotally attached to the conveyor chains such that each of the plurality of benches is conveyable along the bench conveying path. Such plant cultivation systems advantageously allow conveying of the plant benches along the bench conveying path without collision of the plant benches with the lighting system or fluidic system, such as the fluid dispensing tubes, when the plant benches pass the side portions of the bench conveying path.

The plant cultivation system as described herein may be understood to be modular. For example, two or more of plant cultivation systems as described herein may be arranged in a specific relation to each other to form an array of plant cultivation systems. Preferably, two or more plant cultivation systems may be arranged on top of each other to form a vertical array. Additionally, or alternatively, two or more plant cultivation systems may be arranged next to each other to form a horizontal array. Such horizontal and vertical arrays may also be combined depending on the amount of available space and resources.

There is no theoretical limitation to the number of arrays that can be formed. Nonetheless, a typical arrangement may include a vertical array of two stacked plant cultivation systems. This particular arrangement may correspond with the common height of an operator, such that every row of the stacked cultivation systems can be easily reached. It is, however, understood that the array may be expanded even further if tools are provided for the operator to reach the higher located rows, for example an aerial work platform.

Each plant cultivation system in the array of plant cultivation systems may be independently controlled; i.e., the input and output for each plant cultivation system may be processed independently. Preferably, at least a part of the plant cultivation systems in the array of plant cultivation systems may be operationally linked to each other.

In certain embodiments, two or more plant cultivation facilities as taught herein, such as two or more shipping containers (e.g., each comprising two plant cultivation systems as taught herein), may be connected to each other. An operator area may form the area connecting the two or more plant cultivation facilities. The operator area may be located in the centre of the two or more plant cultivation facilities. Thereby, an even more efficient use of space is achieved.

A further aspect provides a plant cultivation facility comprising at least one plant cultivation system as described herein and a housing. In embodiments, the plant cultivation facility may comprise at least two plant cultivation systems as described herein. The at least two plant cultivation systems may be placed one above the other. Preferably, the facility comprises two plant cultivation systems as described herein, wherein the two plant growth systems are placed one above the other.

The terms “housing” or “outer shell” may be used interchangeably herein. In embodiments, the housing may be at least one modular container such as a shipping container (e.g., a 40 ft high-cube reefer container) . The at least one modular container may be capable of being integrated with a plurality of other modular containers to expand the system horizontally or vertically to fit a space. In embodiments, the housing may be an existing building. In embodiments, the housing may be a tailor-made insulated room with a flat floor.

The plant cultivation facility may comprise at least two plant cultivation systems as taught herein, wherein the plant cultivation systems are arranged on top of each other to form a vertical array and/or next to each other to form a horizontal array. The vertical array and/or the horizontal array may be arranged within a housing such as a container or an existing building.

The plant cultivation facility may comprise:

at least one plant cultivation system as described herein, or alternatively, at least one array of plant cultivation systems as described herein; and,

a system configured for controlling one or more plant growing conditions inside the plant cultivation facility.

The plant cultivation facility may comprise a housing. Typically, the housing may form an enclosure around the facility so that it can be sealed off from the outside environment. This may allow for improved control of growing conditions inside the facility.

The housing may be a container. The container may be a large, standardized shipping container, designed and built for transport, meaning that the plant cultivation facility may be easily transported in its entirety requiring little to no mechanical assembly once it has been delivered to a designated location. The container may be a standard ISO shipping container, preferably a high-cube container. High-cube ISO shipping containers are typically 2.44 m (244 cm) wide, 2.90 m (290 cm) high and come in lengths of 12.2 m (1220 cm).

The housing container may be a modular container, which can be operatively connected with one or more other containers, each container housing a plant cultivation system and/or facility as described herein. The advantage of having a plurality of operatively connected containers is that control and monitoring of growing conditions can be assigned into a single location. This may free up space in one or more containers to provide larger plant cultivation systems, thereby further improving the yield of the facility, and/or to provide more space for the operator to perform plant handlings tasks, thereby improving the efficiency of the system.

The housing may be an existing building. Such building may be available and may be adapted with minimal cost to a plant cultivation facility. Additionally, the housing may be a container as described above, which is placed inside or is connected to an existing building.

The plant cultivation facility may comprise a germination rack. The germination rack may provide space for the germination stage of plants. The germination rack is configured for germination of seeds and/or propagation of immature plants. Once the plant has developed it may be transplanted by an operator to a bench of the plant cultivation system as described herein. The germination rack may be a stainless-steel rack with one or more rows (e.g., four rows), each row comprising three plant trays and a lighting system such as LED lighting. The LED lighting may comprise a red light, optional blue light, optional white light (either blue or white is present). The LED lighting may be dimmable. Each layer of led lighting can be turned off separately.

The plant cultivation facility may comprise an operator area. The operator area may provide space for the operator to perform various plant handling tasks. The plant handling may include the actions of introducing plants, transplanting plants, harvesting plants, inspecting plants, removing plants or other plant-related actions. Preferably the operator area is provided at one end of the rack, such that the operator can easily access the plant benches.

The plant cultivation facility may comprise a technical room. The technical area may provide space for the mechanical equipment and its associated electrical equipment. For example, the technical room may provide space for the system for controlling the growing conditions inside the facility or devices thereof, such as one or more control units. The technical area may be located at the back of the plant cultivation facility in particular a container. The technical area may be separated from the growing environment with an insulated panel. The technical area may contain one or more of: an electrical cabinet with the PLC, fuses, LED drivers, etc.; access to the main water tank which may be located on the floor of the plant cultivation facility; a pump to circulate the water; valves to block/open water access to the different irrigation levels; electrical conductivity (EC) and pH sensors; dosing pumps to dose acid/base/nutrient solution in the water; UV filter; space to place a CO₂ canister; space to place nutrient and acid/base canisters. The technical room may be accessed from the back of the plant cultivation facility, e.g., a container for instance by opening the large doors.

The plant cultivation facility may comprise a climate system for controlling various climate-related growing conditions within the plant cultivation facility, which may for example include control of the air temperature, the air humidity, the air flow and/or the air pressure. Preferably, the climate system may comprise a humidifier and/or a dehumidifier for controlling the air humidity. Preferably, humidity sensors are distributed in the racks. This may allow effective humidity control in the plant cultivation facility.

Preferably, the climate system may comprise a temperature controller. The temperature controller may comprise a set of operationally coupled components comprising a control unit, a temperature sensor, and a heating and/or cooling device. The heating and/or cooling device source may be an air-conditioning unit.

Preferably, the climate system may comprise a ventilation system. The ventilation system may comprise pressurized air pumps. By using pressurized air pumps and assuring no air escapes from (the sides of) the system, a homogeneous airflow may be created. In embodiments, the facility may comprise a ventilation system configured for providing an air flow within the growth chamber, wherein the ventilation system is configured for adapting the air flow within the growth chamber according to a predetermined air flow for the plant species. Additionally, the ventilation system may also be configured for controlling the air pressure inside the facility. Preferably, also an air pressure sensor is provided.

The plant cultivation facility may comprise a carbon dioxide (CO₂) system for controlling the carbon dioxide concentration in the plant cultivation facility. The carbon dioxide system may comprise a set of operationally coupled components comprising a control unit, a carbon dioxide sensor, and a carbon dioxide source. The carbon dioxide source may be a cistern comprising liquid carbon dioxide. Alternatively, the carbon dioxide source may be a gas burner.

The plant cultivation facility may comprise an oxygen (O₂) system for controlling the oxygen concentration in the plant cultivation facility. The oxygen controller may comprise a set of operationally coupled components comprising a control unit, an oxygen sensor, and an oxygen source. The oxygen source may be a cistern comprising liquid oxygen.

Each of the above-described growing conditions systems, i.e., the lighting system, the fluidic system, the climate system, the carbon dioxide system and/or the oxygen system, may be independently controlled; i.e., the input and output parameters for each system may be processed and adjusted independently of other systems. Preferably, at least two of the above-described systems are operationally linked to each other to synchronise control of specific growing conditions. For example, the fluid dispensing may be synchronised to the lighting system to simulate day/night cycles or seasonal changes. This may further improve improve growth and/or increase yields of the plants.

The conveyor control unit as described herein may be operationally linked to one or more of above-described growing conditions systems. Preferably, the conveyor control unit may be at least operationally linked to the fluidic system. This linking is particularly preferred in an embodiment wherein fixed number of irrigation zones is formed, so that not all benches can be irrigated at the same time. In this configuration, the fluidic system or a system controlling said fluidic system may provide input to the conveyor control unit to adjust the conveying of benches to the irrigation of benches.

The conveyor control unit may also be connected to a system clock configured to record and track passage of time. The time may be a calendar time, which can be coupled to different growth parameters, or can be a process time, which can be coupled to the time consumed by an executing process. This may allow the conveyor control unit to synchronise the conveying time and speeds to the times of other devices. Alternatively, the conveyor control unit may be controlled by means of a general control system, such as a programmable logic controller (PLC).

In certain embodiments, the plant cultivation facility may further comprise a control system configured for controlling one or more plant growing conditions inside the plant cultivation facility. The parameters of the growing conditions may be controlled by means of a control system, which is operatively coupled to at least one of the above-described lighting system, fluidic system, and/or climate system. The control system may be controlled manually, for example via an input device like a control panel. This may allow an operator to change and monitor specific values of the growing conditions. The control system may also be programmable for automated control. The programming may for example be selected from a list of preprogrammed growing conditions, which may be adjusted to simulate a specific growing environment, such as a particular climate or season, or may be adjusted to optimize the growth of a specific plant or plant species. The manual or automated control may be adjusted locally, for example through an input device provided inside the plant cultivation facility, but may also be performed remotely, for example via remote control hardware and software as known in the art. A further aspect of the present disclosure relates to a method for cultivation of plants, preferably in a plant cultivation system and/or plant cultivation facility as described herein. The method may comprise the following steps:

(a) providing at least one immature plant for cultivation;

(b) conveying a plurality of benches along a bench conveying path until a designated bench reaches a side portion of the bench conveying path, preferably adjacent to an operator area, and then stopping the conveying of benches;

(c) planting the immature plant in the bench positioned at a side portion of the bench conveying path;

(d) conveying the plurality of benches along the bench conveying path until each bench reaches a horizontal portion of the bench conveying path and then stopping the conveying of benches; and

(e) providing growing conditions suitable for plant cultivation, preferably by means of a system configured for controlling one or more plant growing conditions, until the immature plant develops into a mature plant.

A further aspect of the present disclosure relates to a method for batchwise cultivation of plants, preferably in a plant cultivation system and/or plant cultivation facility as described herein. The method may comprise the following steps:

(a) providing one or more immature plants for cultivation;

(b) conveying a plurality of benches along a bench conveying path until at least one bench reaches a side portion of said bench conveying path, and then stopping the conveying of benches;

(c) planting the immature plants in the bench positioned along the side portion of the bench conveying path;

(d) further conveying the plurality of benches along the bench conveying path until every bench reaches a horizontal portion of the bench conveying path, and then stopping the conveying of benches; and

(e) providing growing conditions suitable for plant cultivation until the immature plants develop into mature plants.

Preferably, steps (a) to (c) are repeated until at least a portion of the benches, preferably all of the benches, have been provided with at least one immature plant. It is, however, understood that step (b) may be optional during the first iteration of the present method if a bench is already present at a side portion of the bench conveying path when an immature plant is provided.

The immature plant for cultivation may be seed, seedling and/or plant of at least one plant species, preferably a plurality of seeds, seedlings and/or plants. Preferably the immature plant has been grown in a germination rack as described above.

The system configured for controlling one or more plant growing conditions may comprise a lighting system, a fluidic system, a climate system, an oxygen system and/or a carbon dioxide system as described above. Each component of said system may be configured for providing one or more growing conditions suitable for the cultivation of plants to one or more plants. Once an immature plant has developed into a mature plant, as recited in step (e), it may be harvested. The method may then further comprise the steps of:

(f) conveying the plurality of benches along the bench conveying path until the bench containing the mature plant reaches a side portion of the bench conveying path, preferably adjacent to an operator area, and then stopping the conveying of benches; and,

(g) harvesting of the mature plant.

Preferably, steps (f) and (g) are repeated until at least a portion of the mature plants, preferably all of the mature plants, have been harvested.

In a particular embodiment, wherein the plant cultivation system and/or facility comprises at least reversibly attachable bench, i.e., at least one bench may be reversibly attached and detached from at least one conveyor chain preferably at least two conveyor chains, any steps reciting a handling of a plant, e.g., steps (c) and/or (g), may also comprise the steps of:

detaching of the bench positioned at a side portion of the bench conveying path from the at least two conveyor chains;

performing the one or more plant handling actions, such as planting or transplanting of the immature plant or harvesting of the mature plant; and,

attaching of the detached bench at a side portion of the bench conveying path to the at least two conveyor chains.

In a particular embodiment wherein the plant cultivation system and/or facility comprises at least one retractable lamp, fluid dispensing tube, and/or gutter, any steps reciting a conveying of benches along the bench conveying path, e.g., steps (b) and/or (f), may also comprise the steps of:

retracting of a retractable lamp and/or fluid dispensing tube before or during conveying of a bench along a side portion of the bench conveying path; and,

extending of the retracted lamp and/or fluid dispensing tube after conveying of a bench past a side portion of the bench conveying path or after stopping the conveying of benches.

The step of extending of the retracted lamp, fluid dispensing tube, and/or bench drain spout may be performed each time a bench passes a side portion of the bench conveying path. Advantageously, the step of extending the retracted lamp, fluid dispensing tube, and/or bench drain spout may be performed after stopping the conveying of benches, such that the lamp, fluid dispensing tube, bench drain spout extension/retraction means, for example a linear actuator, does not have to repeatedly activate, which may increase the system lifetime. Preferably, the steps of retracting and/or extending of the retracted lamp, fluid dispensing tube, and/or bench drain spout are performed for every retractable lamp, fluid dispensing tube, and/or gutter in the plant cultivation system and/or facility, if applicable.

The plants may need to be handled during various stages of their growth. The handling of plants may include the actions of introducing plants, transplanting plants, harvesting plants, inspecting plants, removing plants or other plant-related actions. Typically, the plant handling may be performed by an operator, which may be technical personnel of the facility.

The method may be adapted for performing one or more plant handling actions on a bench; in particular, the method may further comprise the steps of:

(A) designating a bench for a plant handling action, optionally by receiving an operator input;

(B) conveying a plurality of benches along a bench conveying path until the designated bench reaches a side portion of the bench conveying path, preferably adjacent to an operator area, and then stopping the conveying of benches; and

(C) performing one or more plant handling actions.

In a particular embodiment more than one plants contained in different benches may need to be handled. In this case, steps (A) to (C) may be repeated until at all plants have been handled. Once the handling of one or more plants, as recited in step (C), has been finished, the method may comprise comprise the step: (D) conveying a plurality of benches along the bench conveying path until each bench reaches a horizontal portion of the bench conveying path and then stopping the conveying of benches.

The plants may need to be irrigated during various stages of their growth. Irrigation as used herein refers to a cycle of dispensing fluid, preferably by means of a fluid dispensing system, and subsequently draining of excess or spent fluid, preferably by means of a fluid draining system. The method may be adapted for performing automated irrigation of one or more benches; in particular, the method may further comprise the steps of:

(i) designating one or more benches for irrigation;

(ii) conveying a plurality of benches along a bench conveying path until the designated benches reach a horizontal portion of the bench conveying path that aligns with a fluidic system, preferably said fluidic system comprising at least one fluid dispensing device and at least one fluid draining device, and then stopping the conveying of benches; and

(iii) irrigating the one or more designated benches.

It is understood that the irrigation method may be performed simultaneously amongst different rows of the system and/or of the facility if each row is provided with the necessary means for performing the method.

In a particular embodiment, the number of designated benches may be greater than the amount of available irrigation zones. The method may then comprise the steps of:

(i) designating two or more benches for irrigation, a first designated bench and a second designated bench;

(ii) conveying a plurality of benches along a bench conveying path until the first designated bench reaches a horizontal portion of the bench conveying path that aligns with a fluidic system, preferably said fluidic system comprising at least one fluid dispensing device and at least one fluid draining device, and then stopping the conveying of benches;

(iii) irrigating the first designated bench;

(iv) conveying a plurality of benches along the bench conveying path until the second designated bench reaches a horizontal portion of the bench conveying path that aligns with the fluidic system;

(v) irrigating the second designated bench.

Preferably, the number of benches in steps (i) to (iii) is adjusted to the amount of available irrigation zones. For example, in an embodiment wherein the system comprises three available irrigation zones, three designated benches may be conveyed to align with the three available irrigation zones and irrigated.

Preferably, the number of benches in steps (iv) to (v) is adjusted to the amount of available designated benches. For example, in an embodiment wherein 24 benches are designated for irrigation, but only four irrigation zones are available, four benches may be conveyed to align with the four available irrigation zones and irrigated. It is understood that in the present example the four available irrigation zones may be provided in a single row, for example. four irrigation zones in the upper row and zero irrigation zones in the lower row, but the four available irrigation zones may be divided amongst the at least two rows, for example two irrigation zones in the upper row and two irrigation zones in the lower row. Steps (iv) to (v) may then be repeated until all of the designated benches have been irrigated. In the present example, of 24 benches and four irrigation zones, steps (iv) to (v) may be repeated at least six times.

In a particular embodiment, the amount of fluid draining systems defining one or more fluid draining zone may be greater than the amount of fluid dispensing systems defining one or more fluid dispensing zones. In this embodiment, the steps of irrigating the designated benches may comprise the steps of:

(I) dispensing fluid into the first designated bench at a fluid dispensing and draining zone;

(II) conveying a plurality of benches along the bench conveying path until the second designated bench aligns with a fluid dispensing and draining zone while the first designated bench remains aligned with a fluid draining zone, and then stopping the conveying of benches;

(III) dispensing fluid into the second designated bench at the fluid dispensing and draining zone, while also draining fluid from the first designated bench at the fluid draining zone.

Preferably, the number of benches in steps (I) to (III) is adjusted to the amount of available fluid dispensing and draining zones. For example, in an embodiment wherein the system comprises three available fluid dispensing and draining zones and three draining zones, then a total of three designated benches may be conveyed to align with the three available fluid dispensing and draining zones.

The methods as described herein may also be carried out by a control unit that is operatively connected to a system for controlling the systems for carrying out the listed steps. Preferably the control unit comprises a computing unit that has been configured for carrying out the methods as described herein. The computing unit may optionally include a computer program comprising instructions which, when the program is executed by said computing unit, may cause the computing unit to carry out the steps of the herein described methods. The computer implementation of the described methods may allow for partial or full automation of the cultivation methods, which can further increase the efficiency of the system.

A further aspect of the present disclosure relates to a use of a plant cultivation system and/or a plant cultivation facility as described herein for conveying benches for the cultivation of plants. The plant cultivation system provides easy transport of the benches in an automated manner, without the need of manually removing the benches from the rack.

A further aspect of the present disclosure relates to a use of a plant cultivation system and/or a plant cultivation facility as described herein for the cultivation of plants. It is understood that any preferred embodiments of the plant cultivation system and/or facility as described herein are also preferred embodiments of the use of said plant cultivation system and/or facility.

The inventors have found that the present disclosure is particularly well suited for cultivation of grasses, leafy greens, vegetables, herbs, succulents, algae, halophytes, flowering plants and/or medicinal plants. Nonetheless, the invention may also be suitable for cultivation of other plant types requiring little to no adjustments.

### EXAMPLES

To better illustrate the properties, advantages and features of the present disclosure some preferred embodiments are disclosed as examples with reference to the enclosed figures. However, the scope of the present disclosure is by no means limited to the illustrative examples described below.

Example 1: Plant Cultivation System According to an Embodiment of the Invention

With reference to FIG. 1, a plant cultivation system (100) according to an embodiment is shown. The plant cultivation system (100) has a rack (300) with two rows arranged one above the other, i.e., an upper row (310) and a lower row (320). A conveyor system (400) is arranged throughout the two rows (310, 320), which comprises at least two endless conveyor chains (410) and a conveyor drive means (450) configured for driving said conveyor chains (410). The conveyor chains (410) are arranged parallel to each other at opposite sides of the rack (300). Each conveyor chain (410) extends longitudinally along the length of the rack (300). The conveyor drive means (450) comprises two pairs of sprocket-wheels located between the two rows (310, 320) at opposite ends of the rack (300), i.e., one pair being located at one end of the rack (300) and the other pair being located at the end opposite thereof. Each conveyor chain (410) passes over two sprocket-wheels, one being located at one end of the rack (300) and the other one being located at the end opposite thereof. The conveyor system (400) further comprises a driving means for effecting the rotation of at least one sprocket-wheel to thereby effect travel of the conveying chains (410) over the rotating sprocket-wheel. The travel of the conveyor chains (410) thereby defines a conveying path having a substantially horizontal portion running along the upper row (310), a substantially horizontal portion running along the lower row (320), and two side portions connecting said substantially horizontal portions between the upper (310) and the lower row (320).

Further, each row of the plant cultivation system (100) is provided with a plurality of plant benches (200) that are spaced along the length of each row (310, 320). Each bench (200) is pivotally attached to both conveyor chains (410), such that travel of the conveying chains (410) effects a conveying of the plurality of benches (200) along the above-defined conveying path. Each bench of said plurality of benches (200) may therefore be continuously conveyed in a loop throughout the two rows (310, 320), i.e., when a bench (200) reaches the end of the upper row (310) it can continue at the start of the lower row (320), and vice versa.

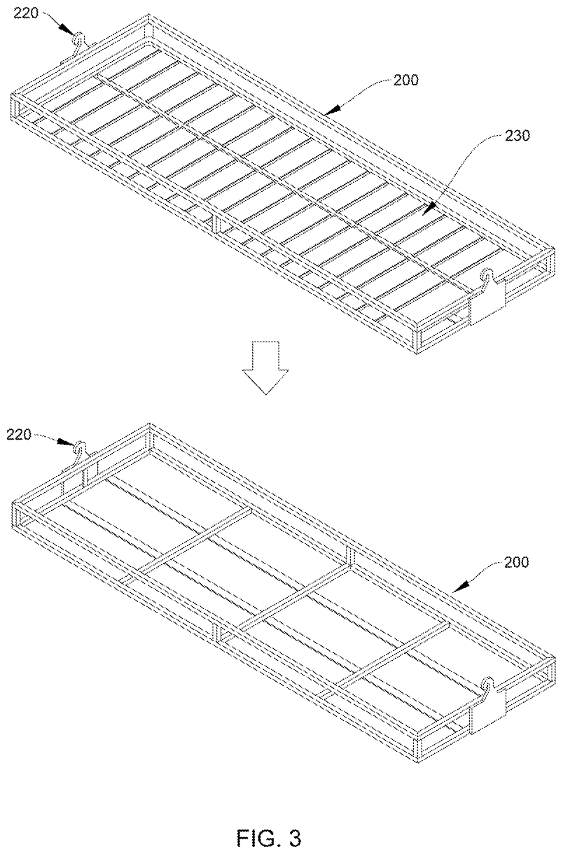

The bench configuration (200) is explained further with reference to FIG. 3. The bench (200) has a body providing space for receiving one or more of trays (230). The trays (230) may be arranged in a way to fill up the entire surface of the bench. Each tray (230) may hold one or more plants (not shown) and the necessary growth medium (not shown). The bench (200) may have an open or closed bottom. As shown in the lower panel of FIG. 3, the bench may have an open bottom. In FIG. 3, upper panel, the bench (200) comprises a tray (230) with dimensions similar to the dimensions of the bench in order to fit the bench. The opposing side walls of each bench (200) are provided with a vertically extending attachment means (220) comprising a hook to attach the bench (200) to the pair of oppositely arranged conveyor chains (410).

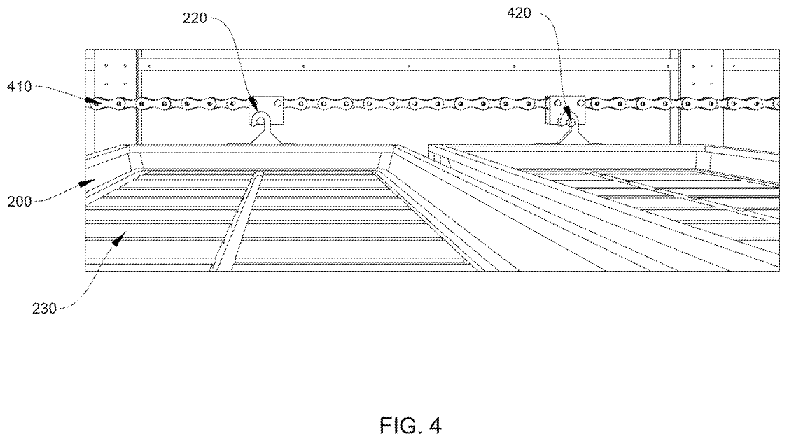

The attachment means (220) for attaching each bench (200) to two oppositely arranged conveyor chains (410) is explained further with reference to FIG. 4. Each conveyor chain (410) is provided with a plurality of transverse members (420), like bolt or lugs, which are arranged transverse to the conveying direction and are horizontally aligned. The two hooks of the attachment means (220) of a bench (200) are hooked over two oppositely arranged transverse members (420), such that the bench is simultaneously supported by two conveyor chains (410). Nonetheless, the bench (200) can still be detached from the two conveyor chains (410) by unhooking the two hooks of the attachment means (220) from the two oppositely arranged transverse members (420); the bench (200) is thus reversibly attached to the conveyor system (400).

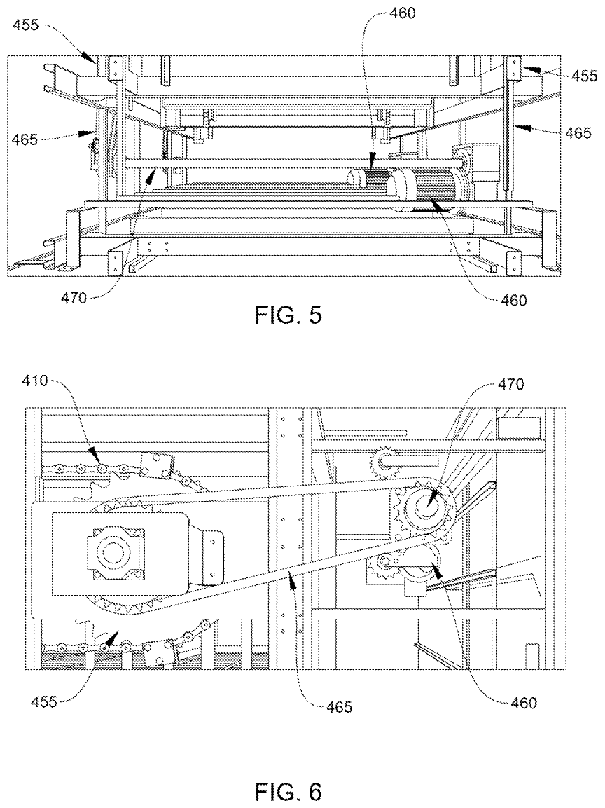

The conveyor drive means (450) is explained further with reference to FIGS. 5 and 6, which show the conveyor drive means (450) from a top view and a side view, respectively. Specifically, the pair of sprocket wheels (455) is driven by a single rotary actuator (460) provided within the rack (300), for example underneath the lower row (320) or above the upper row (310). The rotary actuator (460) is for instance a rotating motor (460) that effects the rotation of a drive shaft (470) through a gear box. Each end of the drive shaft (470) is provided with a drive-wheel and a drive chain (465) passing over the drive-wheel that connects each drive-wheel to a separate sprocket-wheel (455) effecting travel of the above-discussed conveyor chains (410). Rotation of the drive shaft (470) thus effects a synchronised rotation of a pair of oppositely arranged sprocket-wheels (455), i.e., simultaneously effecting travel of the two conveyor chains (410). In the present example a second rotating motor (460) is also provided, which drives the conveyor system (400) of a second plant cultivation system (100), which may be arranged above or below the above-discussed cultivation system (100).

The plant cultivation system (100) may comprise a lighting system (500) and fluidic system (600) as described here below. The plant cultivation system may optionally comprise a climate system. Climatisation may be done by an air-air heat pump system. The internal unit may draw air from the ceiling above the operator area (e.g., located between the plant growing system and the germination rack) and may blow climatized air back through a textile duct towards the back of the plant cultivation system, where the air is evenly distributed between the rows using laminar textile ducts. Optionally, additional fans can be positioned within the rows to create additional airflow. Optionally an additional dehumidification system can be installed. Optionally an additional humidification system can be installed.

Example 2: Plant Cultivation Facility According to an Embodiment of the Invention

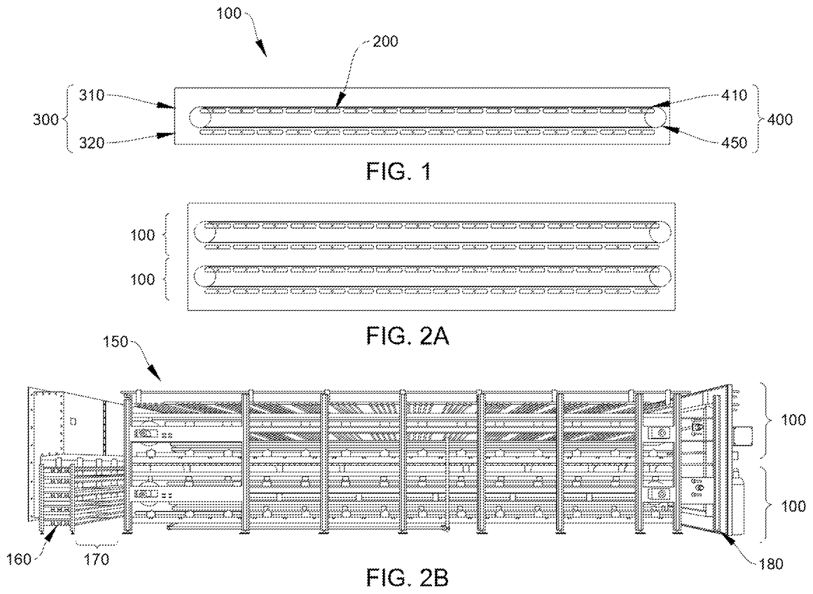

An exemplary arrangement of multiple plant cultivation systems (100) is explained further with reference to FIG. 2A, which is a schematic of a plant cultivation facility (150). Specifically, the present plant cultivation facility (150) has two plant cultivation systems (100) arranged one above the other to form a vertical array of plant cultivation systems (100), i.e., an upper plant cultivation system (100) and a lower plant cultivation system (100). As described above, the conveyor system (400) of each plant cultivation system (100) may be driven by a separate rotary actuator, like a rotating motor, but they may also be driven by a single rotary actuator. FIG. 2B further shows that the plant cultivation facility (150) may be provided with a germination rack (160) and an operator area (170) located at one end of the plant cultivation systems (100), and a technical room (180) at the opposite end thereof.

Example 3: Lighting System of a Plant Cultivation System

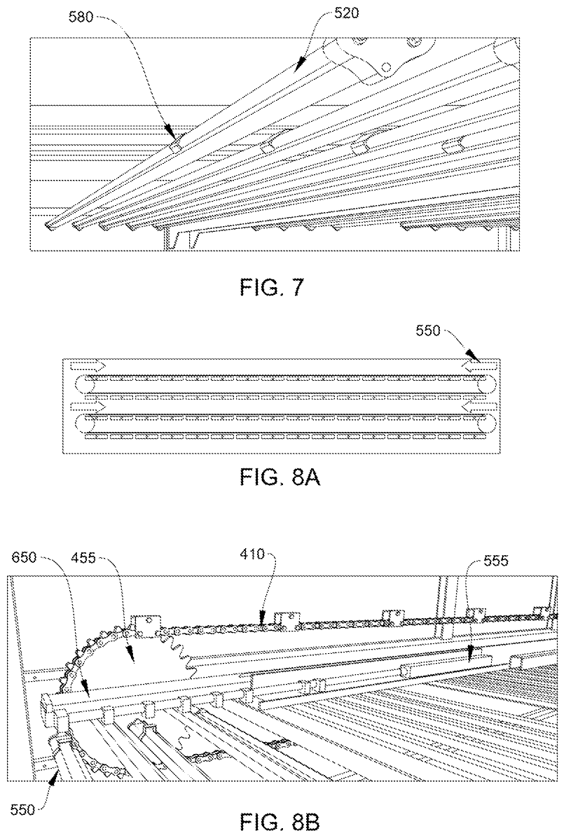

The above-described plant cultivation system (100) or facility (150) may have a lighting system (500), which is first described with reference to FIG. 7. The lighting system (500) comprises a plurality of stationary lamps (520) that are fastened to the ceiling of a row by means of a lamp fastening clip (580). The lamps (520) in the present example are arranged transverse to the conveying direction. Also, some distance may be provided between each lamp (520) depending on the desired lighting conditions. It is appreciated that the lamps are configured to emit light with a wavelength suitable for the cultivation of plants; e.g., promote healthy plant growth. The lighting system (500) also comprises a group of retractable lamps (550) arranged near the end of each row (300), as illustrated in FIGS. 8A and 8B. Each group of retractable lamps (550) is configured to retract into the rack before or during conveying of the plurality of the benches (200). The retractable lamps (550) are fastened by means of a lamp fastening clip (580) to a moveably arranged shaft. A linear actuator is provided in the ceiling of each row (310, 320) to extend and retract said shaft. In this particular example, the linear actuator is a pneumatic valve. Activation of the pneumatic valve effects a horizontal displacement of the group of retractable lamps (550) in the direction indicated by the arrows in FIG. 8A.

Example 4: Fluidic System of a Plant Cultivation System

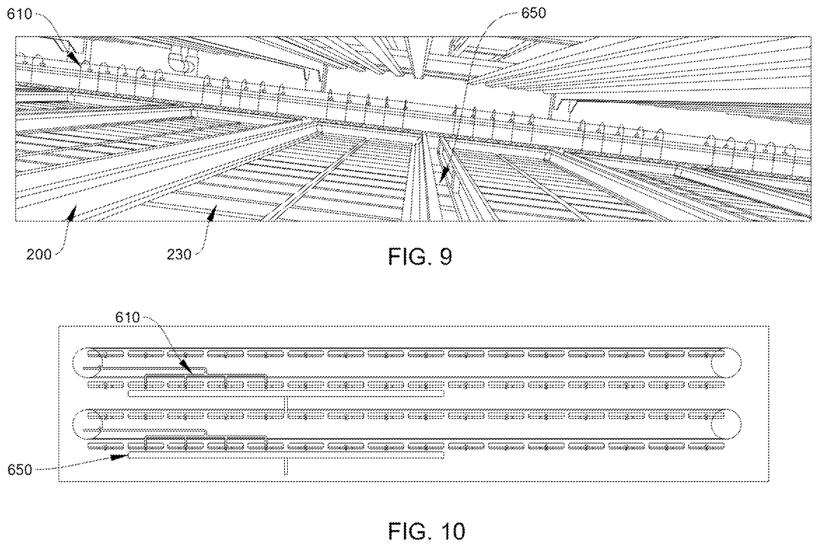

The above-described plant cultivation system (100) or facility (150) may have a fluidic system (600), which is first described with reference to FIG. 9. The fluidic system comprises a plurality of fluid dispensing tubes (610) for dispensing fluid (e.g., nutrient solution) into a plant bench (200), each dispensing tube (610) having an outlet located above the plant benches (200), and further a gutter (650) for draining the dispensed fluid, which is located below the plurality of fluid dispensing tubes (610). It is appreciated that the composition of the provided fluid is adjusted to be suitable for the cultivation of plants; e.g., promote healthy plant growth.

The fluid dispensing tubes (620) and gutter (650) may be arranged throughout the entire length of the upper (310) and/or lower rows (320) of the above-described plant cultivation system (100) or facility (150). Alternatively, the fluidic system (600) may be arranged to form one or more irrigation zones within the above-described plant cultivation system (100) or facility (150).

An exemplary arrangement of an irrigation zone formed between two plant cultivation systems (100) is illustrated in FIG. 10. In this particular example, the fluidic system (600) is arranged to form two irrigation zones spread over two plant cultivation systems (100), i.e., one irrigation zone per plant cultivation system (100). For each irrigation zone the length of the fluid dispensing zone, i.e., corresponding to the provision of fluid dispensing tubes (620), is limited to a specific section along the bench conveying path, for example near the side of the lower row (320) of each plant cultivation systems (100). Also, the length of the fluid draining zone, i.e., corresponding to the length of the gutter (650), is approximately twice the length of the fluid dispensing zone, such that benches (200) that were provided with fluid in fluid dispensing zone may continue draining fluid (e.g., dripping) while travelling further along the bench conveying path. Moreover, the fluid draining zone of the two plant cultivation systems are connected by a sequence of downspouts that guide the drained fluid from an upper gutter (from the upper plant cultivation system) to a lower gutter (from the lower plant cultivation system). The lowest gutter may then guide the fluid to a recycling system to recycle the dispensed fluid.

In this particular example, the length of the fluid dispensing zone of each irrigation zone provides space for simultaneous irrigation of four benches (200). Each bench of the plurality of benches (200) in a single plant cultivation system (100) may be sequentially irrigated by conveying four benches to the four available bench positions in the fluid dispensing zone and, once fully irrigated, conveying these four irrigated benches to the adjacently located four bench positions of the fluid draining zone, thereby also conveying four new benches into the fluid dispensing zone. By sequentially repeating this irrigation process, every bench of the plurality of benches (200) can be irrigated. The irrigation process may be repeated depending on the desired irrigation conditions, e.g., hourly, daily, weekly.

1. A system for cultivation of plants, comprising:
a plurality of benches for cultivating plants;
a rack comprising a pair of elongated rows, one arranged above the other; each row providing space for holding at least two benches and comprising means for providing growing conditions suitable for the cultivation of plants, and each row holding at least two benches;
a conveyor system comprising at least two endless conveyor chains, arranged in a parallel manner on opposite sides of the rack and extending longitudinally along the length of the rack so as to define a bench conveying path having a substantially horizontal portion running along one row, a substantially horizontal portion running along the other row, and two substantially vertical side portions connecting said substantially horizontal portions; wherein every bench is pivotally attached to the conveyor chains and conveyable along said bench conveying path;
wherein the system comprises a conveyor drive for driving the conveyor chains, and a control unit operatively connected to said conveyor drive and configured for controlling the conveyor system to
convey the plurality of benches along the bench conveying path until at least one bench reaches a side portion, and then stopping said bench at a position along the side portion suitable for planting one or more immature plants and/or harvesting of mature plants; and,
convey the plurality of benches along the bench conveying path until every bench reaches a horizontal portion of the bench conveying path, and then stopping the benches at a position along the horizontal portions suitable for providing growing conditions until the immature plants develop into mature plants; and
wherein at a stop position for cultivating of plants each of the plurality of benches is disposed along the rows.

2. The plant cultivation system of claim 1, wherein the two substantially vertical side portions comprise a curved portion arranged along a circular shaped conveyor drive means.

3. The plant cultivation system of claim 20, wherein the at least two rotary actuators are rotatably coupled by a common drive shaft.

4. The plant cultivation system claim 1, wherein each bench is reversibly attached to the conveyor chains; and/or wherein each bench has opposing ends and comprises a conveyor attachment means at each opposing end, and each conveyor chain comprises a transverse member, wherein said conveyor attachment means are hooked over said transverse members such that the bench is reversibly attached to the conveyor chains.

5. The plant cultivation system of claim 1, comprising a lighting system for providing light suitable for the cultivation of plants; said lighting system comprising at least one retractable lamp configured to retract during the conveying of benches along the bench conveying path.

6. The plant cultivation system of claim 1, comprising a fluidic system for providing fluid suitable for the cultivation of plants; wherein the fluidic system comprises at least one fluid dispensing tube for dispensing fluid into the bench and at least one gutter for draining the dispensed fluid; and optionally, at least one bench drain spout for guiding the dispensed fluid from the bench into the gutter.

7. The plant cultivation system of claim 6, wherein the fluidic system comprises at least one retractable fluid dispensing tube (620) configured to retract during the conveying of benches along the bench conveying path.

8. The plant cultivation system of claim 1, comprising a fluidic system for providing fluid suitable for the cultivation of plants; wherein the fluidic system has an irrigation zone that is arranged along the length of one or more bench positions of the row but not at the bench position at the ends of each row.

9. The plant ultivation system of claim 1, wherein the plant cultivation system is comprised in a plant cultivation facility, and wherein the plant cultivation facility comprises a housing for the plant cultivation system.

10. The plant cultivation system of claim 9, wherein the housing is at least one modular container, and/or wherein the housing is an existing building.

11. A method for cultivation of plants in the plant cultivation system of claim 1, the method comprising:
(a) providing one or more immature plants for cultivation;
(b) conveying a plurality of benches along a bench conveying path until at least one bench reaches a side portion of said bench conveying path, and then stopping the conveying of benches;
(c) planting the immature plants in the bench positioned along the side portion of the bench conveying path;
(d) further conveying the plurality of benches along the bench conveying path until every bench reaches a horizontal portion of the bench conveying path, and then stopping the conveying of benches; and
(e) providing growing conditions suitable for plant cultivation until the immature plants develop into mature plants.

12. The method according to claim 11, wherein at least steps (a) to (c) are repeated until every bench contains a plant.

13. The method according to claim 11, further comprising:
(f) conveying the plurality of benches along the bench conveying path until a bench containing one or more mature plants reaches a side portion of the bench conveying path, and then stopping the conveying of benches; and
(g) harvesting of the mature plants from the bench positioned along the side portion of the bench conveying path.

14. The method according to claim 13, wherein at least steps (f) to (g) are repeated until at least a portion of the mature plants have been harvested.

15. The method according to claim 11, further comprising:
designating a bench for a plant handling action, optionally by receiving input from an operator;
conveying the plurality of benches along the bench conveying path until the designated bench reaches a side portion of the bench conveying path, and then stopping the conveying of benches; and
performing one or more plant handling actions on the bench positioned along the side portion of the bench conveying path;
wherein the plant handling actions are selected from the group consisting of introducing plants, transplanting plants, harvesting plants, inspecting plants, treating plants, and removing plants.

16. The method according to claim 11, further comprising:
retracting of at least one retractable lamp during the conveying of benches along the bench conveying path; and,
extending of the retracted retractable lamp after stopping the conveying of benches and every bench is positioned at a horizontal portion of the bench conveying path.

17. The method according to claim 11, further comprising:
designating one or more benches for irrigation;
conveying a plurality of benches along a bench conveying path until the designated benches reach a horizontal portion of the bench conveying path that aligns with a fluidic system configured for irrigating benches and then stopping the conveying of benches; and,
irrigating the one or more designated benches.

18. A plant cultivation system configured for performing the method according to claim 11.

19. (canceled)

20. The plant cultivation system of claim 1, wherein the conveyor drive means comprises at least two rotary actuators configured for driving at least one conveyor chain.

21. The plant cultivation system of claim 9, wherein the plant cultivation facility comprises at least two plant cultivation systems arranged one above the other.
